(19) United States
(12) Patent Application Publication
(10) Pub. No.: US 2013/0080500 A1
(43) Pub. Date: Mar. 28, 2013

(54) ANALYSIS SUPPORTING APPARATUS, ANALYSIS SUPPORTING METHOD, AND RECORDING MEDIUM OF ANALYSIS SUPPORTING PROGRAM

(71) Applicant: Hidenori ISHIKAWA, Yokohama (JP)

(72) Inventor: Hidenori ISHIKAWA, Yokohama (JP)

(73) Assignee: FUJITSU LIMITED, Kawasaki-shi (JP)

(21) Appl. No.: 13/592,862

(22) Filed: Aug. 23, 2012

(30) Foreign Application Priority Data
Sep. 26, 2011 (JP) 2011-208944

(51) Int. Cl. G06F 15/16

(52) U.S. Cl. 709/201

(57) ABSTRACT

An analysis supporting apparatus includes a storage device that stores communication logs obtained from a system, which runs a plurality of programs calling one another, each of the communication logs indicating a relationship of calling among the plurality of programs, and a processor that executes a procedure, the procedure including reading the communication logs concerning a transaction from the storage device that stores, and generating order information indicating an order of programs to be run in the transaction excepting at least a program having been run in the transaction repeatedly a certain number of times on the basis of the read communication logs.

### CROSS-REFERENCE TO RELATED APPLICATIONS

This application is based upon and claims the benefit of priority of the prior Japanese Patent Application No. 2011-208944, filed on Sep. 26, 2011, the entire contents of which are incorporated herein by reference.

### FIELD

The embodiments discussed herein are related to analysis of processing procedure.

### BACKGROUND

A business flow is formed by small tasks (instances) such as receiving orders, grouping orders and placing orders which are successively processed by staff members who are in charge of the respective tasks in general, so that the entire business flow is achieved. The business flow is called a business process. A recent trend in dealing with such a business flow is that an IT (Information Technology) device in an IT system runs software, i.e., business applications each corresponding to each of the instances so that the instances are each processed.

Such a business application invokes software which runs a process when the IT device runs each of the business applications. The invoked software is called component software, and a function that the IT device obtains by running the component software is called a component.

That is, if a business application invokes certain component software, the IT device which processes the invoked component software runs the component software so as to run a process corresponding to what is invoked.

Further, the business applications each transfer an outcome of the process to another IT device or to another business application in the same IT device in some cases.

A consecutive process achieved in this case by means of communication between the business applications or with a component is called a transaction.

When the communication is performed to achieve the transaction, the IT device outputs log data according to the process run by the business application or component which performs the communication. The log data includes information on a component to be invoked by a plurality of business applications in common, a component forming an infrastructure of the IT system, etc.

According to known technology, component information related to a business process is automatically collected from transaction log data of consecutive transactions exchanged among applications and network nodes in an IT system. As the transaction log data of the business process collected by the IT system is formed by pieces of information on a component, i.e., a smallest unit of the business process, the data is collected with regard to the business process with too fine granularity. If the information is collected owing to the transaction log data, e.g., information regarding the business process is collected on a protocol basis of communication raised between network ports or on a class method basis of the business application. Thus, it is desirable to filter information on the components and to visualize information only on a component concerned in a primary business process in order to make an analysis from a viewpoint of the business process.

A known technology for collecting, analyzing and visualizing transaction data is, e.g., to preset a particular method concerned in a business process of a business application outputting transaction log data upon being run.

Further, another known method is to capture a communication packet and preset the packet being treated as transaction log data if a particular character string is included in a header or URL of an HTTP request.

According to the technologies described above, however, only a preset transaction is to be dealt with and an unanticipated case may be missed.

### SUMMARY

According to an aspect of the invention, an analysis supporting apparatus includes a storage device that stores communication logs obtained from a system, which runs a plurality of programs calling one another, each of the communication logs indicating a relationship of calling among the plurality of programs, and a processor that executes a procedure, the procedure including reading the communication logs concerning a transaction from the storage device that stores, and generating order information indicating an order of programs to be run in the transaction excepting at least a program having been run in the transaction repeatedly a certain number of times on the basis of the read communication logs.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a relationship between a business process and transactions;

FIG. 2 is a block diagram which illustrates an example of a hardware constitution of a data processing device;

FIG. 3 illustrates an example of a log data analysis system;

FIG. 4 illustrates an exemplary hardware constitution of a log data analysis device;

FIG. 5 illustrates an example of transaction log data;

FIG. 6 illustrates an example of a transaction;

FIG. 7 illustrates an example of a process for excluding a recursive component;

FIG. 8 illustrates an example of a process for excluding a recursive component;

FIG. 9 illustrates an example of a process for excluding a component located in a loop;

FIG. 10 illustrates an example of a process for excluding a component located in a loop;

FIG. 11 illustrates an example of a process for excluding a successively processed component;

FIG. 12 illustrates an example of a process for excluding a successively processed component;

FIG. 13A illustrates an example of exceptions to a process for excluding a component;

FIG. 13B illustrates an example of exceptions to a process for excluding a component;

FIG. 14 illustrates an example of a process for analyzing a transaction log data;

FIG. 15 illustrates an example of a process for analyzing a transaction log data;

FIG. 16 illustrates an example of a process for analyzing a transaction log data;

FIG. 17 illustrates an example of a process for analyzing a transaction log data;

FIG. 18 illustrates an example of a process for analyzing a transaction log data;

FIG. 19 illustrates an example of a process for analyzing a transaction log data;

FIG. 20 illustrates an example of a process for analyzing a transaction log data;

FIG. 21 illustrates an example of a process for analyzing a transaction log data;

FIG. 22 is an exemplary flowchart of a process for analyzing a transaction log data;

FIG. 23 illustrates an example of a table of a first embodiment;

FIG. 24 illustrates an example of a table of the first embodiment;

FIG. 25 illustrates an example of a table of the first embodiment;

FIG. 26 illustrates an example of a table of the first embodiment;

FIG. 27 is a flowchart which depicts a process for visualizing a transaction log data;

FIG. 28 illustrates an example of a table of the first embodiment;

FIG. 29 illustrates an example of a table of the first embodiment;

FIG. 30 illustrates an example of a table of the first embodiment;

FIG. 31 illustrates an example of a transaction log data after an excluding process;

FIG. 32 illustrates an example of a result of a process;

FIG. 33 illustrates an example of a transaction log data;

FIG. 34 illustrates an example of a table of a second embodiment;

FIG. 35 illustrates an example of a table of the second embodiment;

FIG. 36 illustrates an example of a table of the second embodiment;

FIG. 37 illustrates an example of a table of the second embodiment;

FIG. 38 illustrates an example of a table of the second embodiment;

FIG. 39 illustrates an example of a table of the second embodiment;

FIG. 40 illustrates an example of a table of the second embodiment;

FIG. 41 illustrates an example of a table of the second embodiment;

FIG. 42 illustrates an example of a result of a process; and

FIG. 43 illustrates an example of a result of a process.

### DESCRIPTION OF EMBODIMENTS

A data processing system of a first embodiment will be explained below.

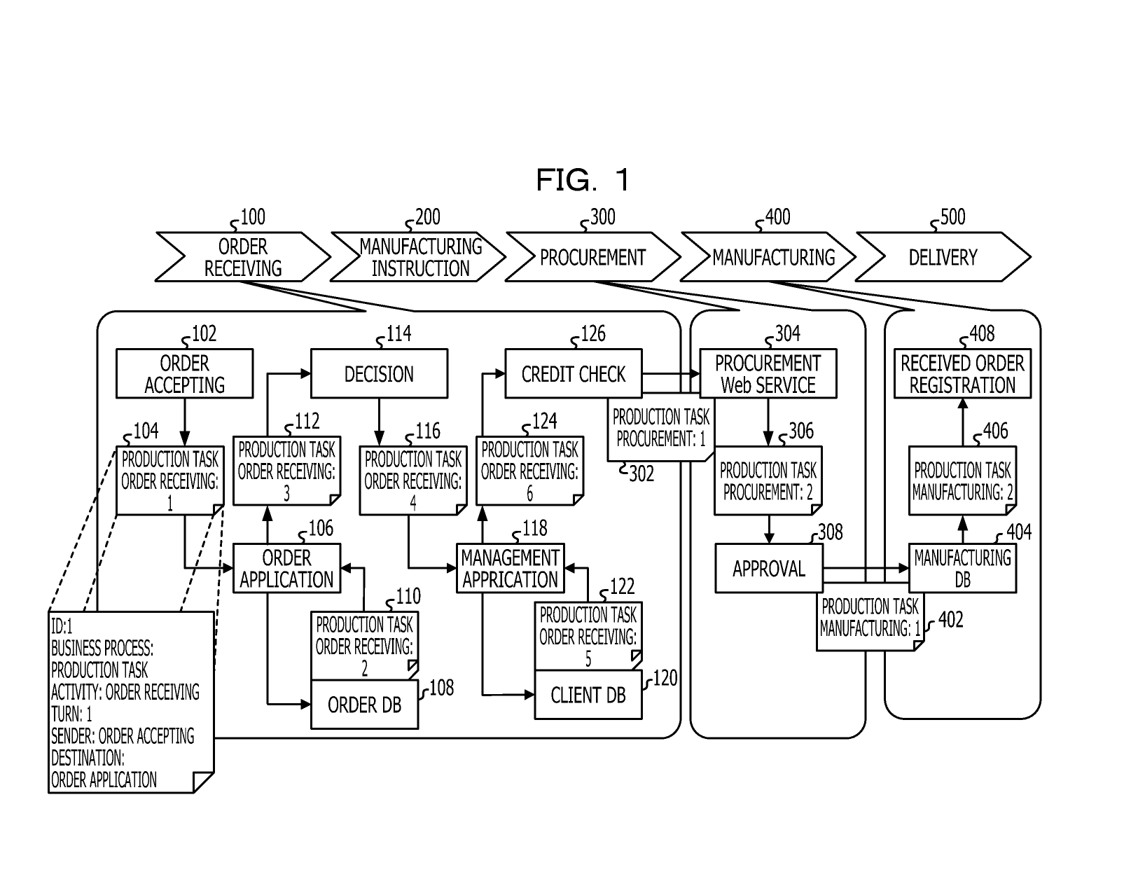

FIG. 1 illustrates an example of a relationship between a business process and transactions. Call a data processing unit into which information transfers and a data processing flow in an IT system regarding one instance in the business process are gathered a transaction. Incidentally, the IT system of the embodiment is formed by a plurality of data processing devices communicably connected with one another via a communication network. One of the data processing devices in the IT system runs component software or application software so as to work as each of components or applications described below. Further, suppose that logs of a transaction, i.e., a consecutive process achieved by means of communication among the respective components and applications (described later) is stored in a data processing device which runs a relevant component or application. Logs stored in the data processing device may be a part of the logs of the transaction. The logs stored in the data processing device may be selected on the basis of a given condition (fro example, indicating execution of a particular method concerned in a business process of a business application).

The business process is formed, e.g., by an order receiving process 100, a manufacturing instruction process 200, a procurement process 300, a manufacturing process 400 and a delivery process 500.

The order receiving process 100 is formed by an order accepting component 102, an order application component 106, an order DB 108, a decision component 114, a management application component 118, a client DB 120 and a credit check component 126. The data processing device accepts an order given by a client as processed by the order accepting component 102. The data processing device runs an ordering process on the basis of the order accepted by the order accepting component 102 as processed by the order application component 106. The ordering process run by the order application component 106 is stored in the order DB 108. The data processing device gives a decision as processed by the decision component 114. The data processing device runs a management process for clients as processed by the management application component 118. The management process run by the management application component 118 is stored in the client DB 120. The data processing device runs a credit check process as processed by the credit check component 126.

The data processing device outputs transaction log data 104 as processed by the order accepting component 102. Each time the order accepting component 102 transmits a transaction, the order accepting component 102 stores transmission history of the transaction in the transaction log data 104. The transaction log data 104 includes information on a transaction ID, i.e., an identifier specific to every transaction, a business process, activity, a turn, a sender and a destination. The ID includes information for identifying the transaction log data in the order accepting process 100. The business process indicates a name of a business process run by the relevant transaction. The activity indicates a name of a process being run in the business process. The turn indicates a turn of being run in the activity. The sender indicates a sender of the transaction log data 104. As the sender of the transaction log data 104 is the order accepting component 102, the sender is “order accepting” in FIG. 1. The destination indicates a destination of the transaction log data 104. As the destination of the transaction log data 104 is the order application component 106, the destination is “order application” in FIG. 1.

The data processing device similarly runs following settings of transaction log data 110, transaction log data 112, transaction log data 116 and 122, and transaction log data 124 as processed by the order application component 106, the decision component 114, the management application component 118 and the credit check component 126, respectively.

The procurement process 300 is formed by a procurement Web service component 304 and an approval component 308. The data processing device runs a procurement Web service as processed by the procurement Web service component 304. The data processing device runs an approval process as processed by the approval component 308.

Incidentally, the data processing device runs settings of transaction log data 302 and transaction log data 306 as processed by the procurement Web service component 304 and the approval component 308, respectively.

The manufacturing process 400 is formed by a manufacturing DB 404 and a received order registration component 408. The approval process run by the approval component 308 is stored in the manufacturing DB 404. The data processing device runs a received order registration process as processed by the received order registration component 408.

Incidentally, the data processing device sets transaction log data 406 as processed by the received order registration component 408.

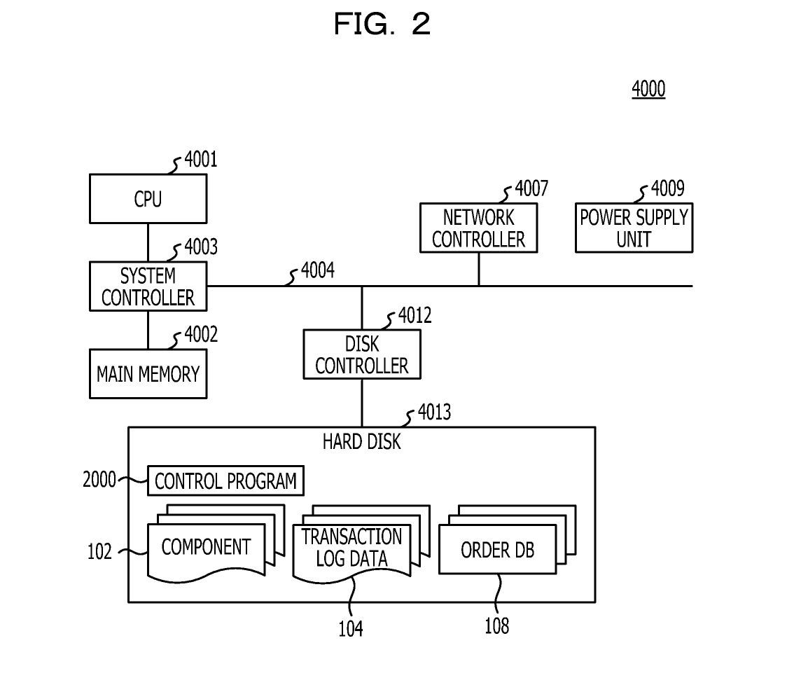

FIG. 2 is a block diagram which illustrates an example of a hardware constitution of each of data processing devices 4000 in the IT system of the embodiment. The data processing device 4000 runs the various kinds of components and applications described above.

The data processing device 4000 is controlled by a CPU (Central Processing Unit) 4001. The CPU 4001 is an example of a processor which reads out and executes programs (various kinds of components and applications described above) from the main memory 4002. The processor is a hardware to carry out operations based on at least one program (such as the analysis supporting program) and control other hardware, such as the CPU 4001, a GPU (Graphics Processing Unit), FPU (Floating point number Processing Unit) and DSP (Digital signal Processor).

The CPU 4001 is connected with a system controller 4003, and so is a main memory 4002. The system controller 4003 controls data transfer between the CPU 4001 and the main memory 4002 and between the CPU 4001 and a bus 4004. Further, the system controller 4003 is connected with a network controller 4007 and a disk controller 4012 via the bus 4004.

At least a portion of an OS (Operating System) or application program to be run by the CPU 4001 is temporarily filed in the main memory 4002. Further, various kinds of data that the CPU 4001 uses for data processing are filed in the main memory 4002. A RAM (Random Access Memory), e.g., is used as the main memory 4002.

The disk controller 4012 is connected with a hard disk 4013. The disk controller 4012 controls the hard disk 4013.

A plurality of application programs including the order accepting component 102 and the management application component 118 is filed in the hard disk 4013, and so are a control program 2000 which makes the CPU 4001 controls a call for an application program, etc., and various kinds of DBs including the order DB 108. Further, the transaction log data 104, etc., is filed in the hard disk 4013.

The network controller 4007 transmits and receives data to and from the CPU 4001 or the hard disk 4013.

The hardware components in the data processing device 4000 are each supplied with power by a power supply unit 4009 via a power supply line not depicted in FIG. 2.

The CPU 4001 runs various kinds of programs filed in the hard disk 4013 so that the data processing device described above achieves functions of the various kinds of components and applications.

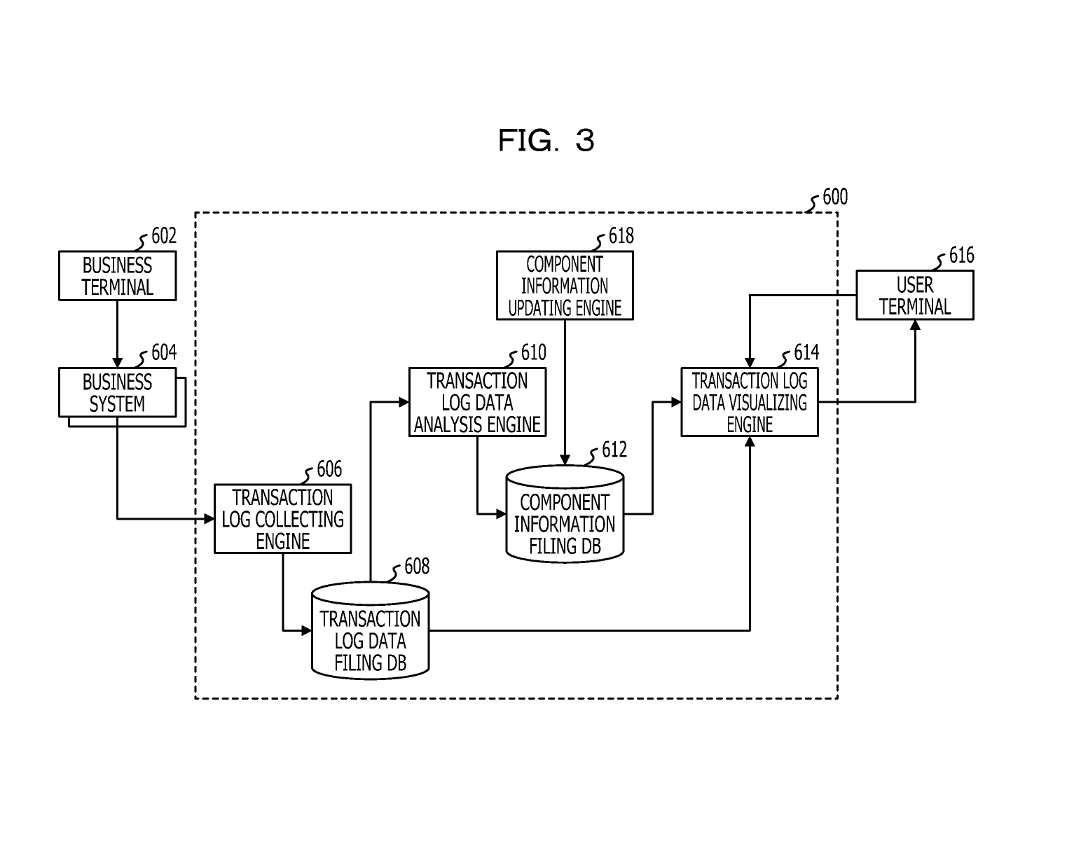

FIG. 3 is a block diagram which illustrates an example of a log data analysis system of the embodiment. The log data analysis system has a business terminal 602, a business system 604, a log data analysis device 600 and a user terminal 616.

The log data analysis device 600 has a transaction log collecting engine 606, a transaction log data filing DB 608, a transaction log data analysis engine 610, a component information filing DB 612, a transaction log data visualizing engine 614 and a component information updating engine 618.

The log data analysis device 600 collects transaction log data as processed by the transaction log collecting engine 606.

Transaction log data collected by a transaction log data collecting engine 606 is filed in the transaction log data filing DB 608. The transaction log data includes component information. The component information includes a name of a business process, a transaction ID that an instance in the business process may be uniquely identified on the basis of, and information that a processing order of a component such as a component name of a sender may be identified on the basis of. That is, upon referring to the information, the log data analysis device 600 may connect every transaction in the transaction log data with one instance in the business process.

The log data analysis device 600 analyzes what kind of component information is included in every block of transaction log data that the business system 604 has collected from the business terminal 602 as processed by the transaction log data analysis engine 610.

The component information analyzed by the transaction log data analysis engine 610 is stored in the component information filing DB 612.

The log data analysis device 600 successively analyzes pieces of component information included in one transaction as processed by the transaction log data analysis engine 610. Incidentally, suppose that a transaction is given a unique transaction ID and may be uniquely identified on the basis of the transaction ID.

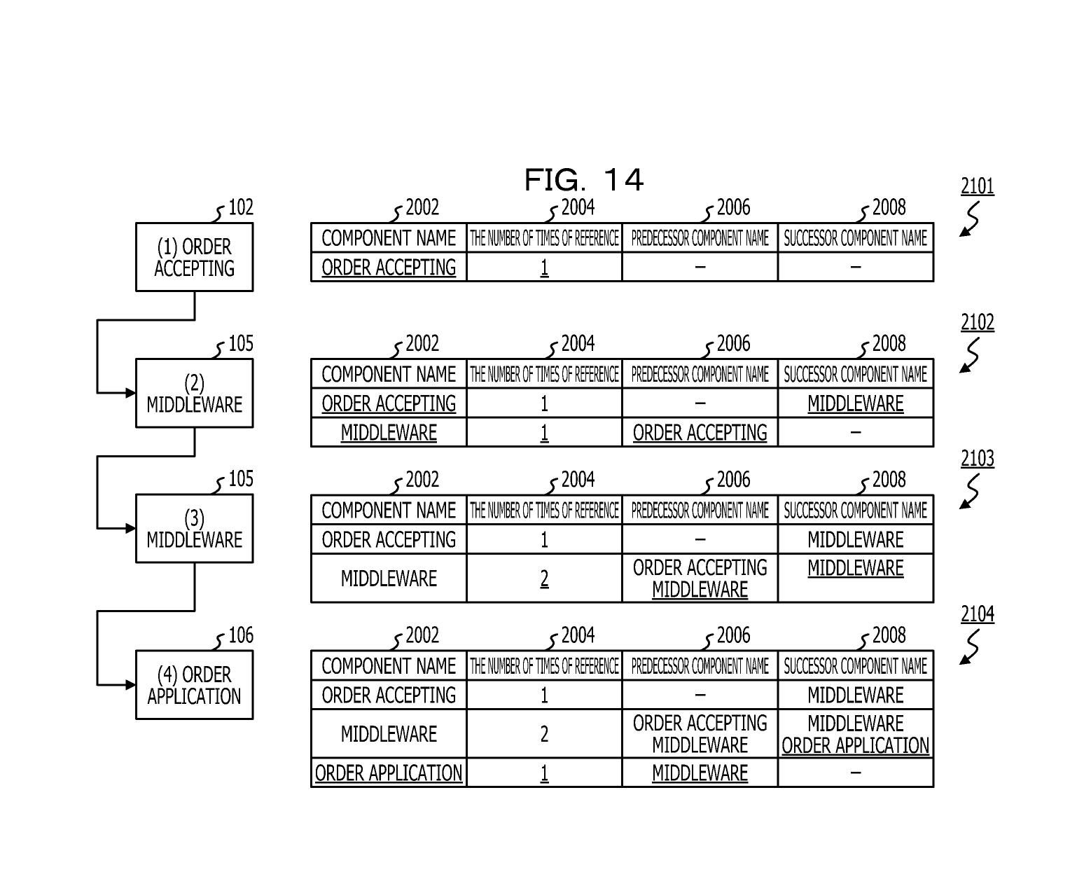

The log data analysis device 600 refers to a transaction ID included in a certain piece of component information and decides whether another piece of information having a same transaction ID and a same component name as those of the piece of component information having been referred to is in the component information filing DB 612 as processed by the transaction log data analysis engine 610. Unless such a piece of component information is in the component information filing DB 612, the log data analysis device 600 records a name of a business process, a transaction ID, a turn of the component in the transaction and a component name as registration of a new piece of component information and sets “1” to the number of times the component is referred to as processed by the transaction log data analysis engine 610. If such a piece of component information is present, the log data analysis device 600 adds “1” to the number of times the component is referred to as un update of an existing component as processed by the transaction log data analysis engine 610. Further, the log data analysis device 600 adds a component name filed in the component information filing DB 612 to a line of a previous component name as processed by the transaction log data analysis engine 610. Incidentally, the line will be described later by the use of FIG. 14.

The log data analysis device 600 decides whether a certain piece of component information is first one in the transaction as processed by the transaction log data analysis engine 610. Unless the piece of component information is first one, the log data analysis device 600 puts a name of the present component into a line of a component name just succeeding the component name filed in the component information filing DB 612 as processed by the transaction log data analysis engine 610. If the piece of component information is first one, the log data analysis device 600 stores the component name into the component information filing DB 612 as processed by the transaction log data analysis engine 610. The component information regarding the transaction is thereby filed in the component information filing DB 612.

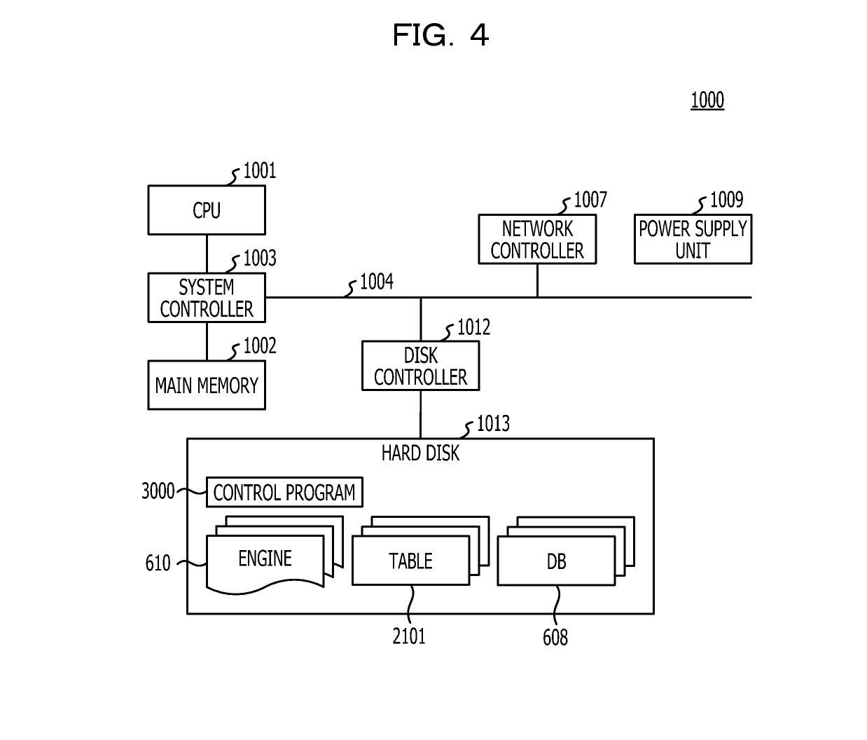

FIG. 4 is a block diagram which illustrates an exemplary hardware constitution of the log data analysis device 600 of the embodiment.

A data processing device 1000 is controlled by a CPU 1001. The CPU 1001 is an example of a processor which reads out and executes the transaction log data analysis engine 610 (including an analysis program or an analysis support program) from the main memory 1002. The processor is a hardware to carry out operations based on at least one program (such as the analysis support program) and control other hardware, such as the CPU 1001, a GPU (Graphics Processing Unit), FPU (Floating point number Processing Unit) and DSP (Digital signal Processor).

The CPU 1001 is connected with a system controller 1003, and so is the main memory 1002. The system controller 1003 controls data transfer between the CPU 1001 and the main memory 1002, and between the CPU 1001 and a bus 1004. Further, the system controller 1003 is connected with a network controller 1007 and a disk controller 1012 via the bus 1004.

At least a portion of an OS program and an application program (for example, the analysis support program) to be run by the CPU 1001 is temporarily filed in the main memory 1002. Further, various kinds of data to be used by the CPU 1001 for data processing are filed in the main memory 1002. A RAM, e.g., is used as the main memory 1002.

The disk controller 1012 is connected with a hard disk 1013. The disk controller 1012 controls the hard disk 1013.

The OS and a plurality of engines to be processed by the CPU 1001 including the transaction log data analysis engine 610 are filed in the hard disk 1013, and so are a control program 3000 which makes the CPU 1001 run a control operation such as invoking an application program, and various kinds of DBs including a table 2101, etc., and the transaction log data filing DB 608. Incidentally, the table 2101, etc., will be described later. An analysis supporting program includes the plurality of engines and the control program, for example.

The network controller 1007 transmits and receives data to and from the CPU 1001 or the hard disk 1013.

The hardware components in the data processing device 1000 are each supplied with power by a power supply unit 1009 via a power supply line which is not depicted.

The CPU 1001 develops the analysis program and the analysis support program on the main memory 1002 and runs those programs, so that the transaction log collecting engine 606 runs data processing as described above, and so do the transaction log data analysis engine 610, the component information updating engine 618 and the transaction log data visualizing engine.

The log data analysis device 600 identifies a component on the basis of collected transaction log data as processed by the transaction log data analysis engine 610 as described above. Further, if a transaction formed by consecutive transmission and receiving operations achieved by means of communication among components is identified, a transaction path may be identified. Thus, the log data analysis device 600 of the embodiment identifies a transaction path on the basis of the collected transaction log and the information on the identified component as processed by the transaction log data analysis engine 610.

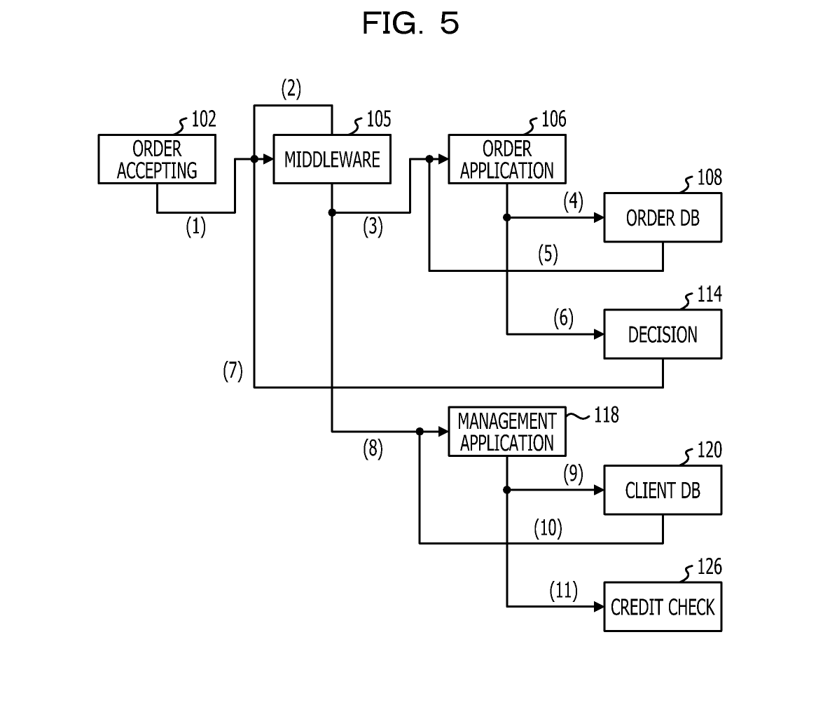

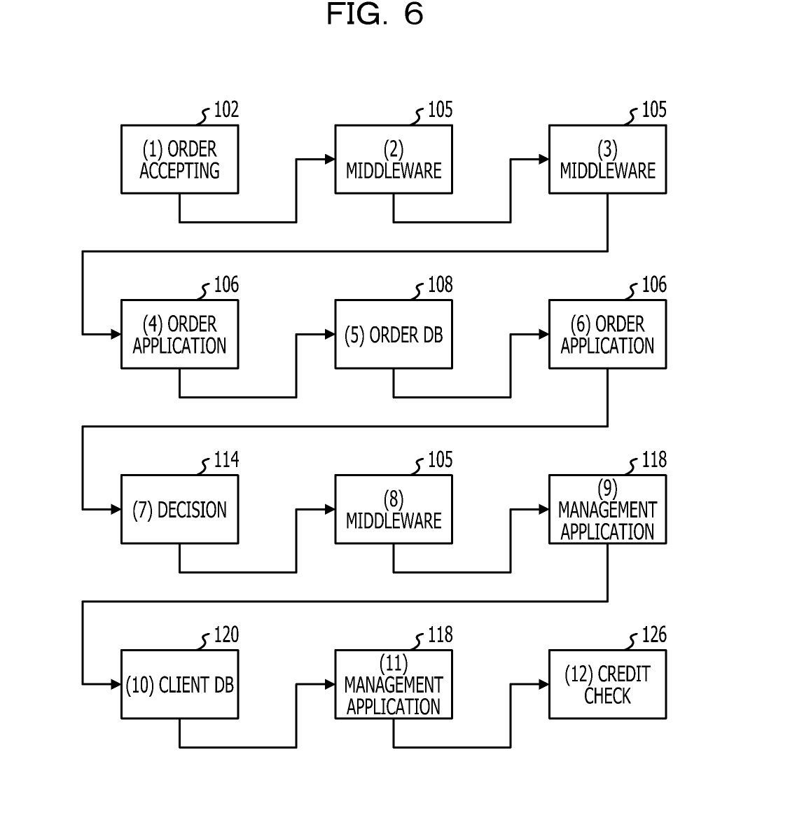

FIG. 5 illustrates an example of the identified path which will be explained below. FIG. 6 illustrates the transaction path illustrated in FIG. 5. Incidentally, some of the drawings derived from FIGS. 5 and 6 each indicate a component name with a numeral in parentheses which indicates the turn of the component in the sequentially depicted transaction for convenience. Suppose that the component name practically includes no numeral in parentheses.

According to the embodiment, while any object to be visualized is neither predefined nor leaked from huge transaction log data in visualizing and analyzing a business process, a learning process or reasoned accumulation allows undesired component information to be automatically excluded. Specifically, automatically collected transaction log data exchanged among applications of the IT system running business processes and network nodes allows a business process run by the relevant transaction to be visualized.

When a business process is visualized by the use of transaction log data in an IT system, remove component information undesired to be analyzed or visualized as explained below with regard to the embodiment. Exclude component information undesired to be analyzed or visualized from collected transaction log data by using a following method. A result of analyzing the business process to be analyzed may be made less redundant on an aspect.

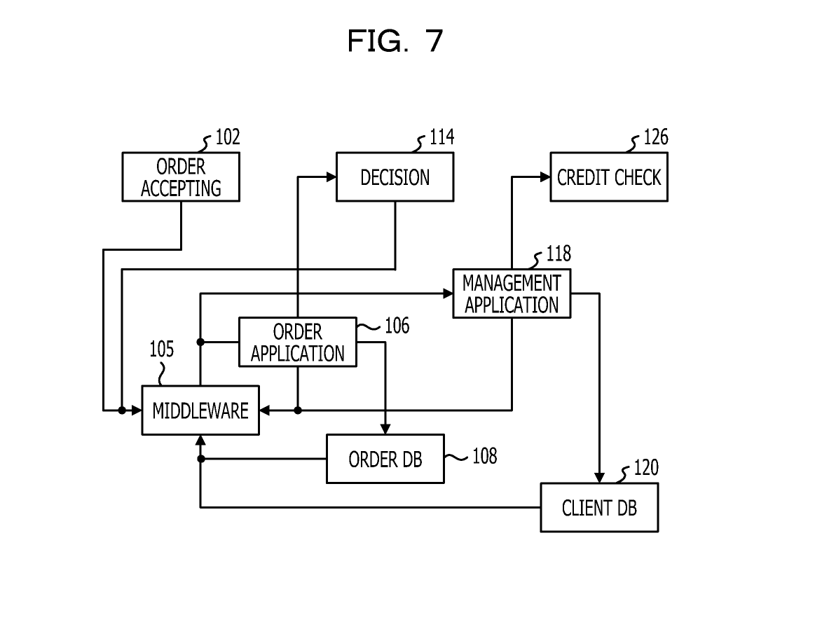

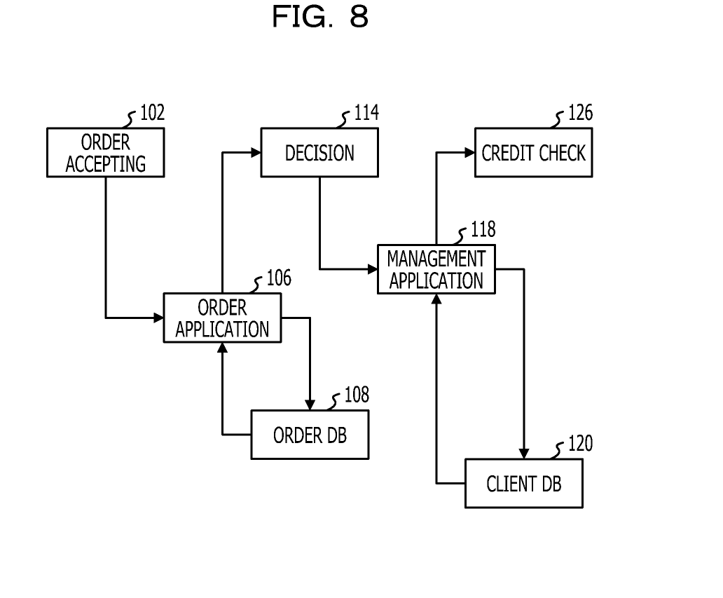

FIG. 7 illustrates an example of the collected transaction log data which will be explained below. It is automatically decided that a recursive component referred to plural times on the transaction path, etc., is of component information provided by the infrastructure or middleware of the IT system. Remove the component information of the decision from information in which components are arranged in order of being run. FIG. 7 illustrates an exemplary transaction path on which a middleware component 105 is referred to plural times by another component. FIG. 8 illustrates an example of the information in which components are arranged in order of being run that the middleware component 105 is removed from.

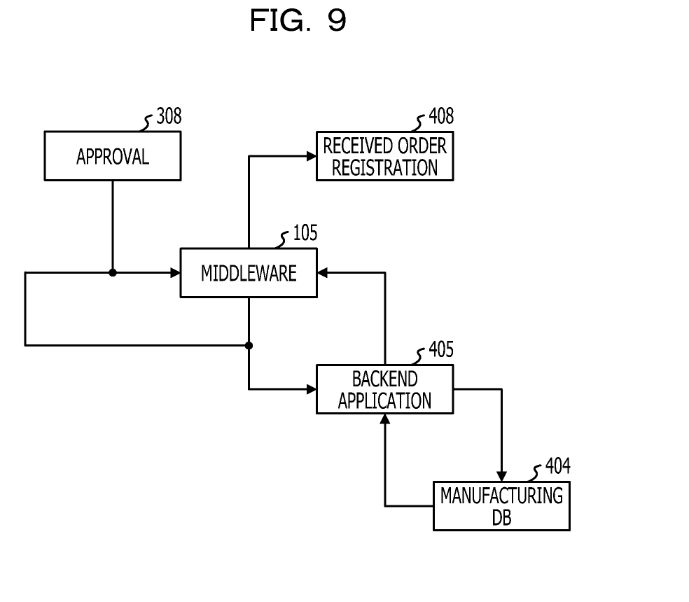

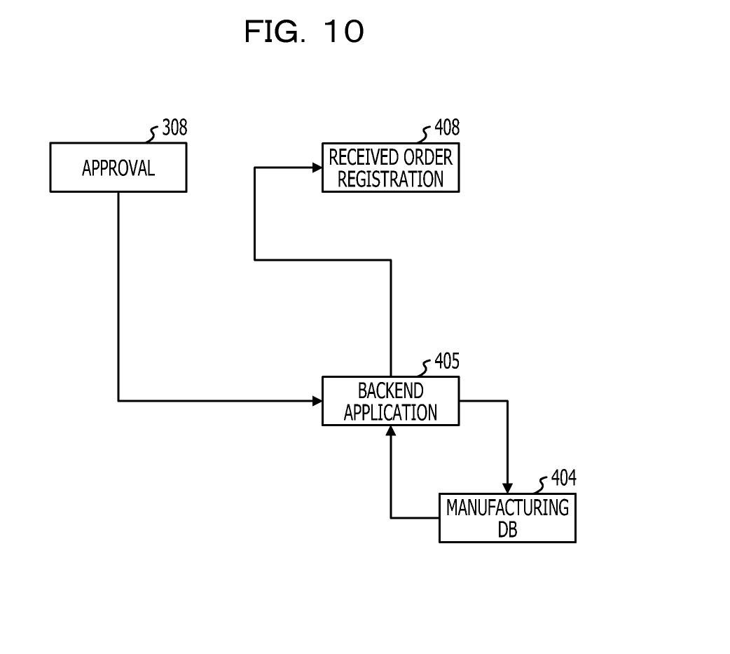

FIG. 9 illustrates an example of the collected transaction log data which will be explained below. It is automatically decided that a component located in a loop is of component information provided by the infrastructure or middleware of the IT system. Remove the component information from information in which components are arranged in order of being run. FIG. 9 illustrates an example in which the middleware component 105 is located in a loop. FIG. 10 illustrates an example of the information in which components are arranged in order of being run that the middleware component 105 is removed from.

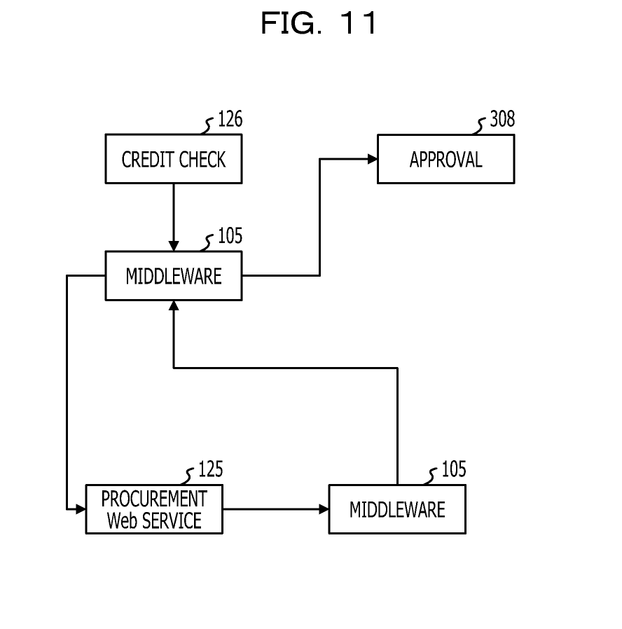

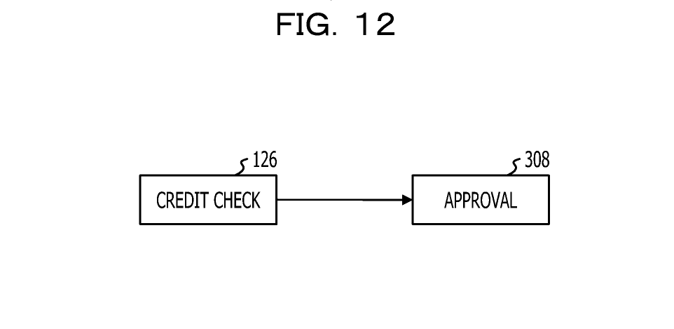

FIG. 11 illustrates an example of the collected transaction log data which will be explained below. Exclude component information successively processed without branching off from the transaction path. At this time, automatically identify and remove component information to be excluded from a result of an analysis of accumulated transaction log data. In FIG. 11, e.g., the middleware component 105 is excluded as being of a component referred to plural times by another component. Further, a procurement Web service 125, etc., is excluded as being a successively processed component. FIG. 12 illustrates an example of the information in which components are arranged in order of being run that the middleware component 105 and the procurement Web service component 125 are removed from.

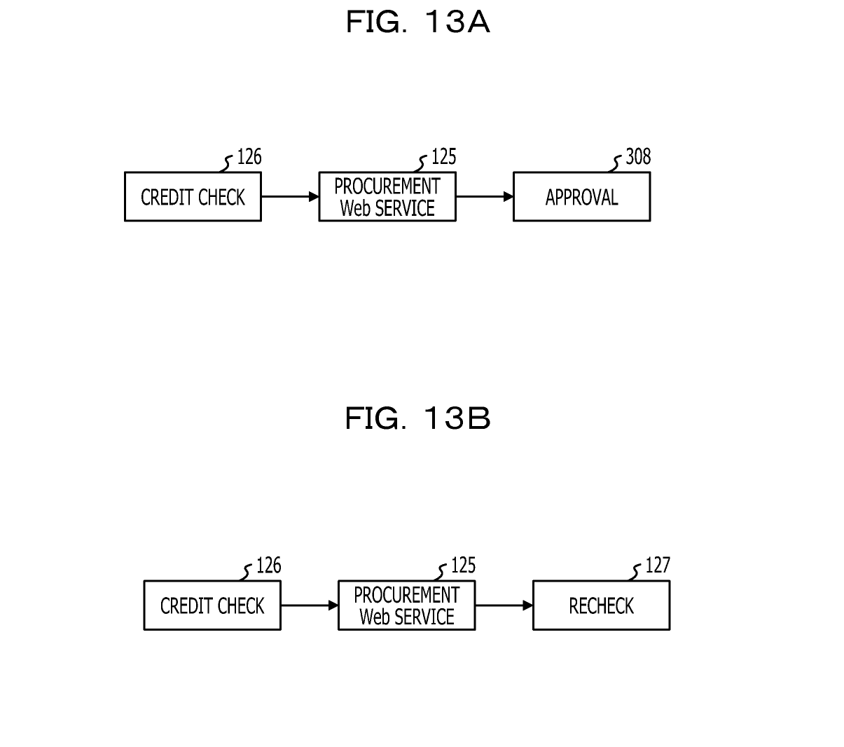

FIGS. 13A and B illustrates an example of the collected transaction log data which will be explained below. In FIGS. 13A and B, e.g., although the procurement Web service component 125 looks like a component to be successively processed, an approval component 308 and a recheck component 127 are processed next to the procurement Web service component 125. Information of a component where the process successively continues without branching off on one transaction path but branches off to another component on another transaction path is not to be excluded in this way. Automatically combine the above processes with one another so as to cleanse transaction log data and visualize the cleansed data as a business process.

The log data analysis device 600 analyzes component information filed in the component information filing DB 612, decides whether the relevant information is excluded from what is to be visualized, and reflects the decision in the component information filing DB 612 as processed by the component information updating engine 618 in this way. The log data analysis device 600 decides whether a piece of component information is to be excluded from what is to be visualized as processed by the component information updating engine 618 according to following three criteria.

The CPU 1001 decides whether a process returns to a same piece of component information. To return to a same piece of component information means, e.g., that a component next to a component “order processing” is “order processing”, again. As the relevant criterion is closed in one transaction, the CPU 1001 may make a decision for every transaction.

Further, the CPU 1001 decides whether a piece of component information is of a component having been referred to plural times. That it is of a component having been referred to plural times means, e.g., that a component “Web page indication” has appeared plural times in one transaction. As the relevant criterion is closed in one transaction, the CPU 1001 may make a decision for every transaction.

Further, the CPU 1001 decides whether a piece of component information is of a component where the process continues without branching off. That it is of a component where the process continues without branching off means, e.g., that a component “ordering process” is followed by “order settlement” every time. As the relevant criterion does not have content closed in one transaction, it is desirable for the CPU 1001 to analyze a plurality of transactions in one business process. Although, e.g., the “ordering process” is followed by the “order settlement” in most of the transactions, the “ordering process” may be conceivably followed by “order cancellation” in some of the transactions. Thus, it is desirable to run the component information updating engine 618 upon transaction log data piling up with regard to a certain business process to a certain extent.

The component information updating engine 618 may be run, e.g., at scheduled intervals, every time the transaction log data analysis engine finishes analyzing transaction log data, or may be explicitly updated by a user. The term scheduled intervals means here once a day, once a week, etc.

The process explained by the use of FIGS. 7-13 will be explained by the use of FIG. 14. Suppose that no information is registered in the component information filing DB 612 yet with regard to a business process name “ordering task” and a transaction ID “0001”. The CPU 1001 applies a process to the order accepting component resulting in a table 2101. The table 2101 has a line formed by a component name 2002, the number of times of reference 2004, a predecessor component name 2006 and a successor component name 2008. The component name 2002 indicates a name of a component to be processed by the data processing device. The number of times of reference 2004 indicates how many times the component to be processed by the data processing device is referred to. The predecessor component name 2006 indicates a name of a component processed just before the component to be processed by the data processing device. The successor component name 2008 indicates a name of a component to be processed just after the component to be processed by the data processing device. At this time, “order accepting” is temporarily stored in the table 2101. A process of the embodiment to add a component name to the line formed by the component name 2002, the number of times of reference 2004, the predecessor component name 2006 and the successor component name 2008 will be explained.

The CPU 1001 applies a process to the middleware component resulting in a table 2102. The CPU 1001 puts “middleware” into a successor component name of an order accepting component temporarily stored in the table 2102, and puts “order accepting” into a predecessor component name of the middleware component, and “middleware” is temporarily stored in the table 2102.

The CPU 1001 applies a process to the middleware component resulting in a table 2103. As the middleware component is present in the table 2102, add one to the number of times of reference which is updated to “2”. The CPU 1001 puts “middleware” into a successor component name of the middleware component temporarily stored in the table 2102, and puts “middleware” into a predecessor component name of the middleware component, and “middleware” is temporarily stored in the table 2103.

The CPU 1001 applies a process to the order application component resulting in a table 2104. The CPU 1001 puts “order application” into a successor component name of the middleware component temporarily stored in the table 2102, and puts “middleware” into a predecessor component name of the order application component, and “order application” is temporarily stored in the table 2104.

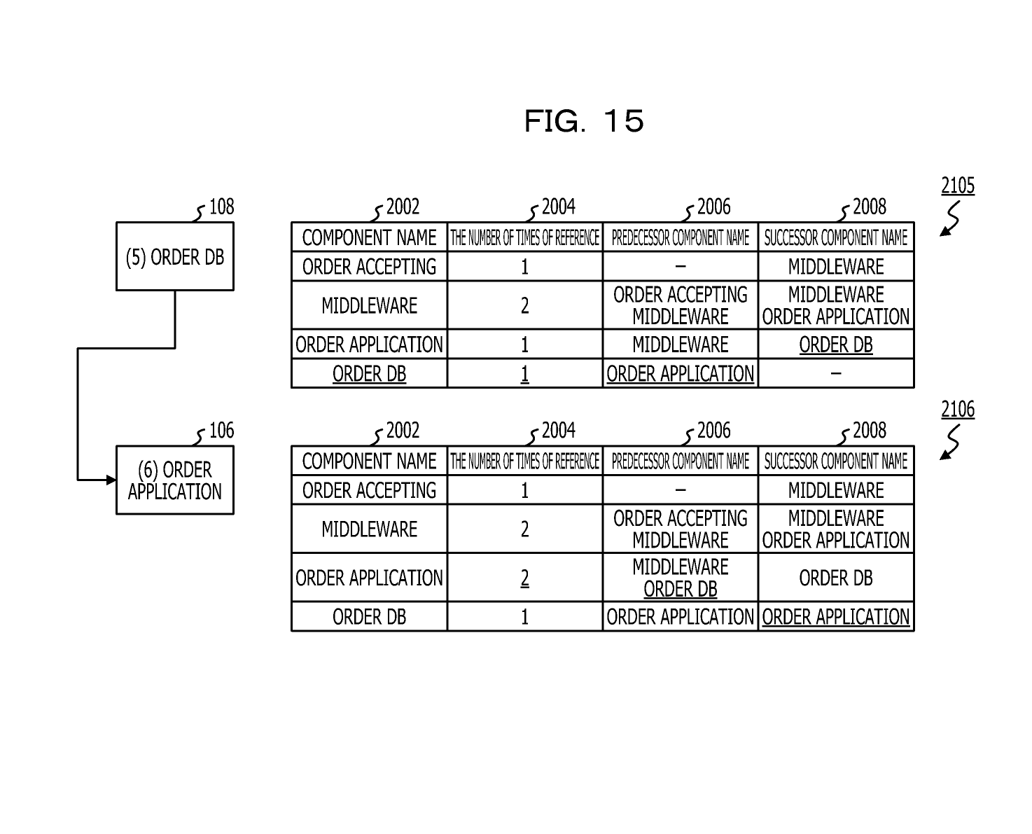

The process explained by the use of FIGS. 7-13 will be explained by the use of FIG. 15. The CPU 1001 applies a process to the order DB component resulting in a table 2105. The CPU 1001 puts “order DB” into a successor component name of the order application component temporarily stored in the table 2104, and puts “order application” into a predecessor component name of the order DB component, and “order DB” is temporarily stored in the table 2105.

The CPU 1001 applies a process to the order application component resulting in a table 2106. As the order application component is already present, the CPU 1001 adds one to the number of times of reference which is updated to “2”. The CPU 1001 puts “order application” into a successor component name of the order DB component temporarily stored in the table 2105, and puts “order DB” into a predecessor component name of the order application component, and “order application” is temporarily stored in the table 2106.

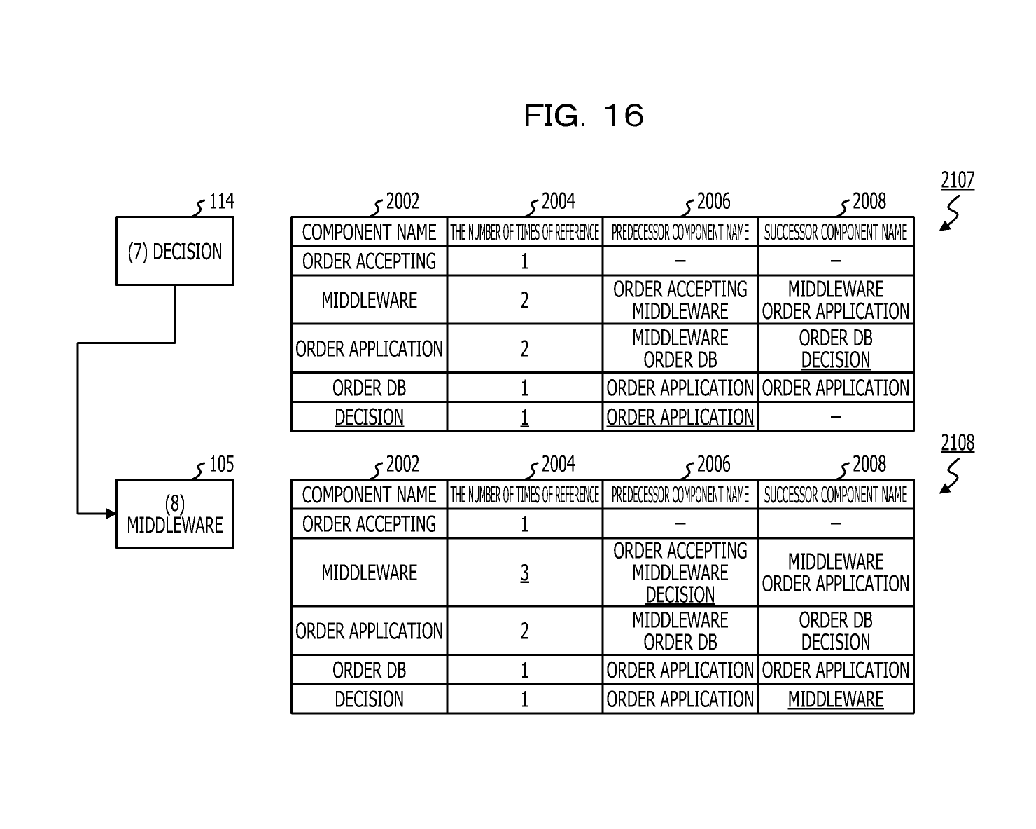

The process explained by the use of FIGS. 7-13 will be explained by the use of FIG. 16. The CPU 1001 applies a process to the decision component resulting in a table 2107. The CPU 1001 puts “order DB” into a successor component name of the order application component temporarily stored in the table 2106, and puts “order application” into a predecessor component name of the decision component, and “decision” is temporarily stored in the table 2107.

The CPU 1001 applies a process to the middleware component resulting in a table 2108. As the middleware component is already present in the table, the CPU 1001 adds one to the number of times of reference which is updated to “3”. The CPU 1001 puts “middleware” into a successor component name of the decision component temporarily stored in the table 2107, and puts “decision” into a predecessor component name of the middleware component, and “middleware” is temporarily stored in the table 2108.

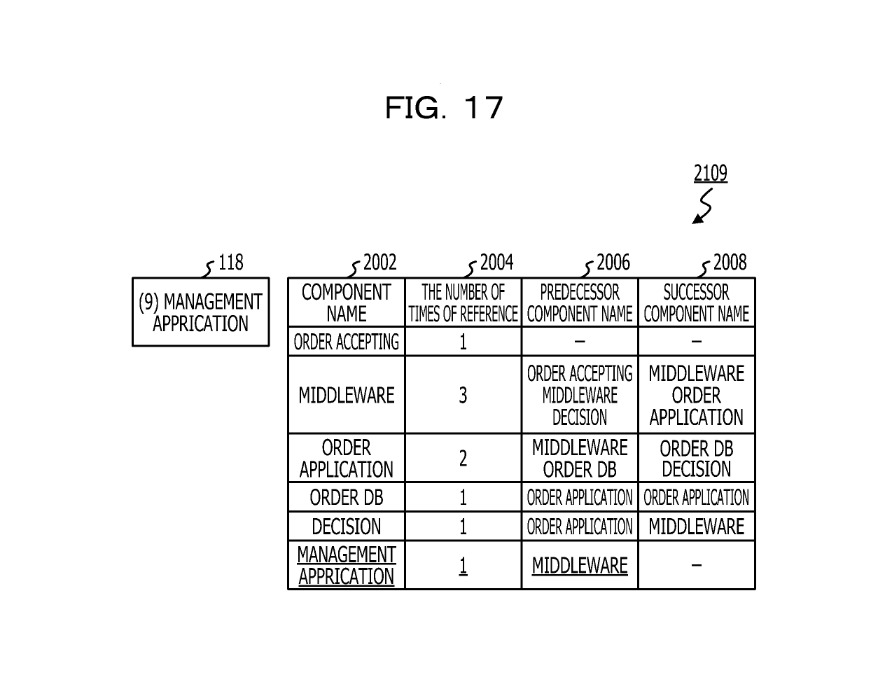

The process explained by the use of FIGS. 7-13 will be explained by the use of FIG. 17. The CPU 1001 applies a process to the management application component resulting in a table 2109. The CPU 1001 puts “management application” into a successor component name of the middleware component temporarily stored in the table 2108, and puts “middleware” into a predecessor component name of the management application component, and “management application” is temporarily stored in the table 2109.

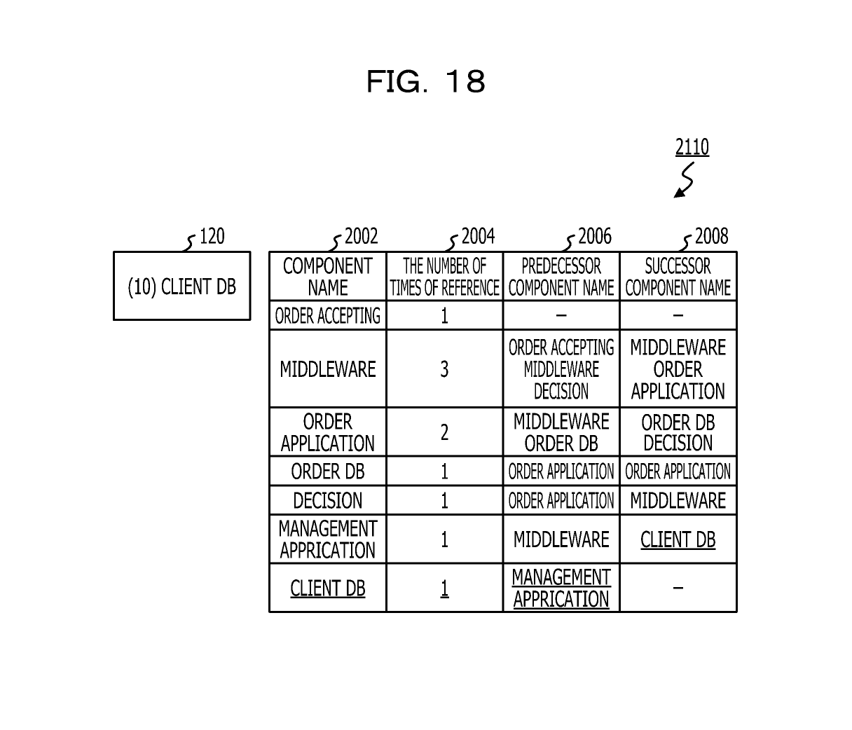

The process explained by the use of FIGS. 7-13 will be explained by the use of FIG. 18. The CPU 1001 applies a process to the client DB component resulting in a table 2110. The CPU 1001 puts “client DB” into a successor component name of the management application component temporarily stored in the table 2109, and puts “management application” into a predecessor component name of the client DB component, and “client DB” is temporarily stored in the table 2110.

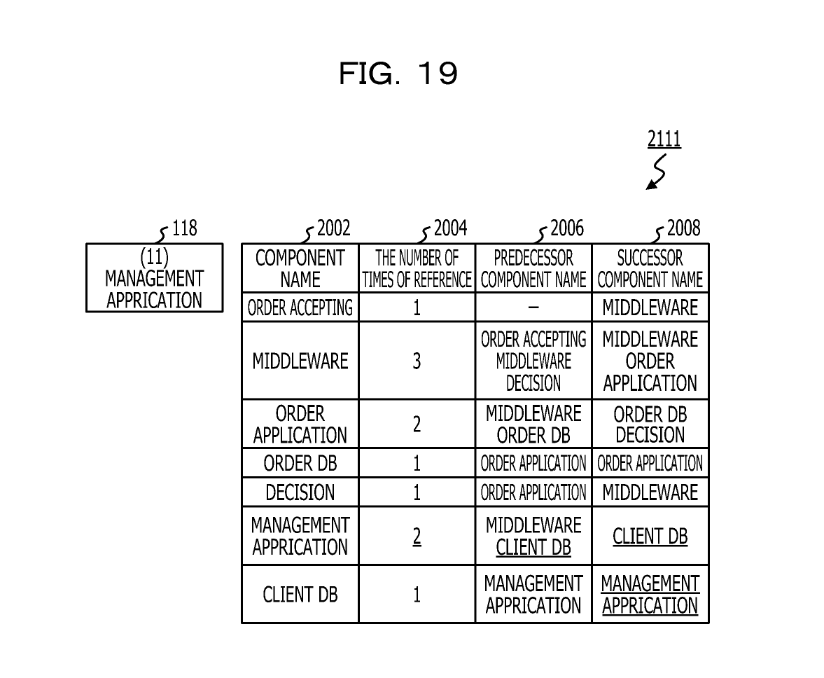

The process explained by the use of FIGS. 7-13 will be explained by the use of FIG. 19. The CPU 1001 applies a process to the management application component resulting in a table 2111. As the management application component is already present in the table, the CPU 1001 adds one to the number of times of reference which is updated to “2”. The CPU 1001 puts “management application” into a successor component name of the client DB component temporarily stored in the table 2110, and puts “client DB” into a predecessor component name of the management application component, and “management application” is temporarily stored in the table 2111.

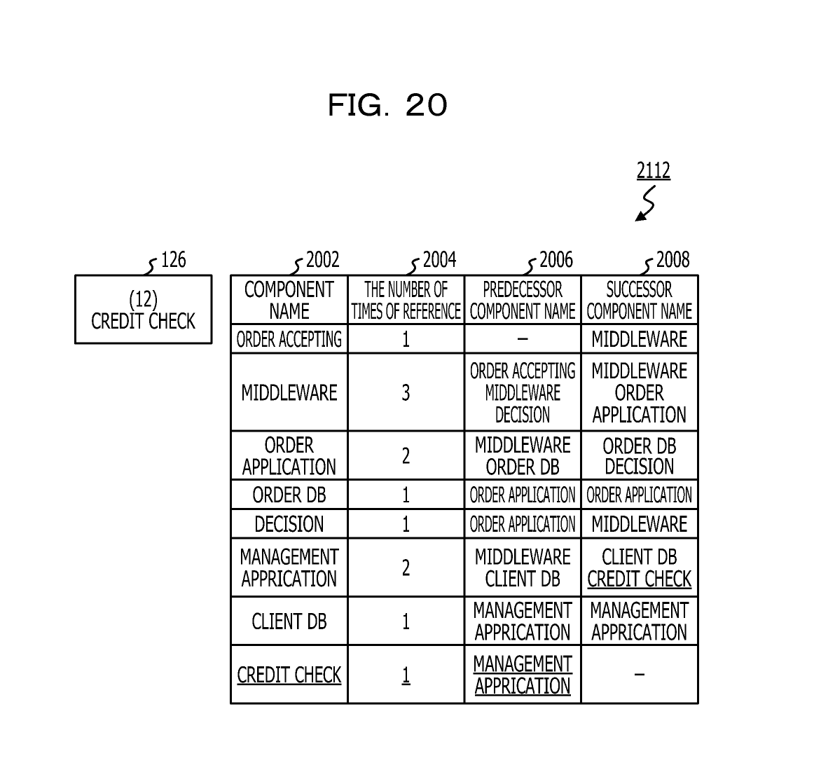

The process explained by the use of FIGS. 7-13 will be explained by the use of FIG. 20. The CPU 1001 applies a process to the credit check component resulting in a table 2112. The CPU 1001 puts “credit check” into a successor component name of the management application component temporarily stored in the table 2111, and puts “management application” into a predecessor component name of the credit check component, and “credit check” is temporarily stored in the table 2112.

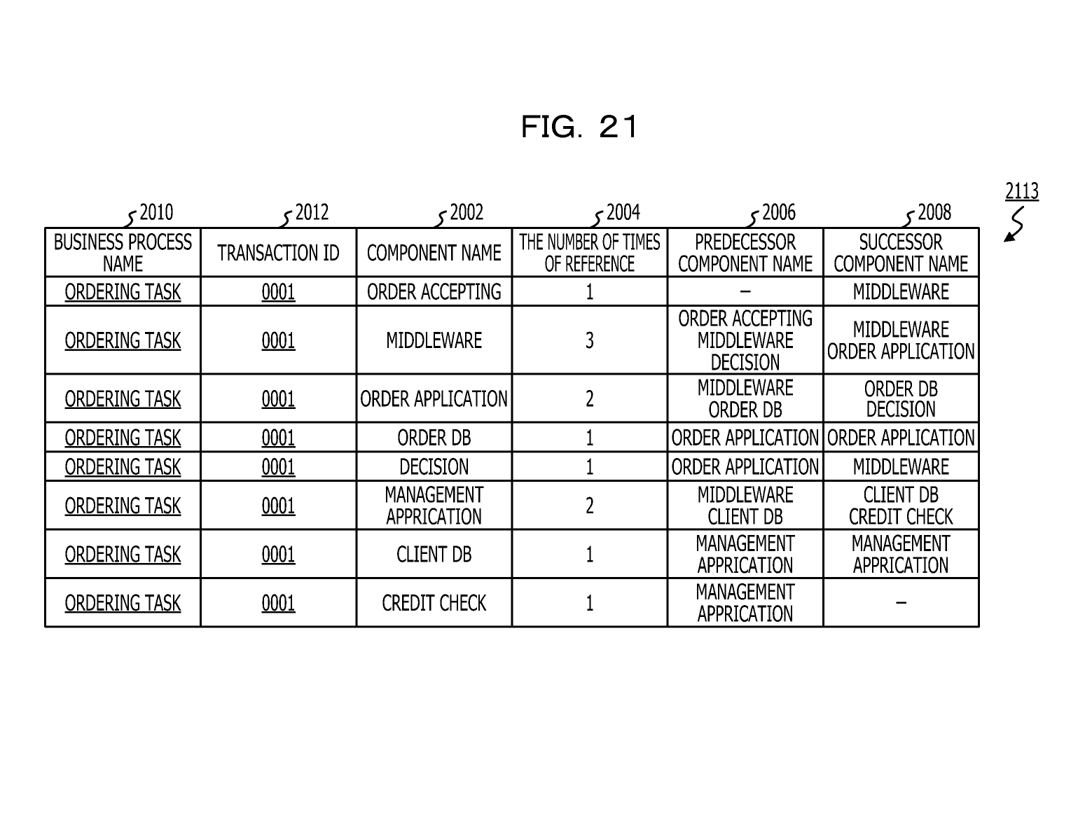

As a result, the CPU 1001 connects a business process name 2010 with a transaction ID 2012 to form a table 2113 as depicted in FIG. 21. The CPU 1001 stores the table 2113 in the component information filing DB 612.

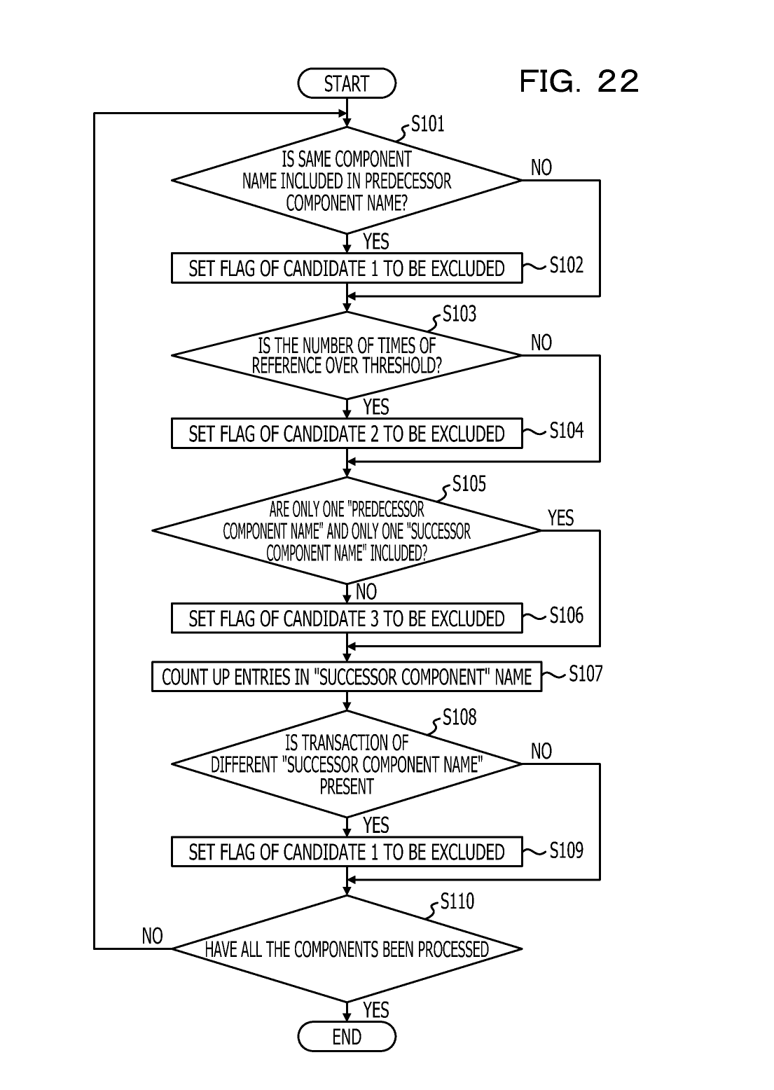

A process run by the component information updating engine 618 will be explained by the use of FIG. 22.

The CPU 1001 decides whether the “predecessor component name” in component information of a certain component includes a same component name as that of the relevant component at a S101. If the “predecessor component name” includes a same component name as that of the relevant component, the CPU 1001 shifts the process to a S102. Meanwhile, unless the “predecessor component name” includes a same component name as that of the relevant component, the CPU 1001 shifts the process to a S103.

The CPU 1001 sets a flag of a candidate 1 to be excluded to a visible flag at the S102. The CPU 1001 shifts the process to the S103.

The CPU 1001 decides whether the “number of times of reference” in the same component information values over a threshold specified in advance at the S103. Suppose that the threshold is given an initial value “2”. Incidentally, the threshold is updated by the transaction log data visualizing engine 614 described later. If the “number of times of reference” values over the threshold specified in advance, the CPU 1001 shifts the process to a S104. Unless the “number of times of reference” values over the threshold specified in advance, the CPU 1001 shifts the process to a S105.

The CPU 1001 sets a flag of a candidate 2 to be excluded to the visible flag at the S104. The CPU 1001 shifts the process to the S105.

The CPU 1001 decides whether the same component information includes only one “predecessor component name” and only one “successor component name” at the S105. If only one “predecessor component name” and only one “successor component name” are included, the CPU 1001 shifts the process to a S106.

The CPU 1001 sets a flag of a candidate 3 to be excluded at the S106. The CPU 1001 shifts the process to a S107.

If the candidate 3 to be excluded is set, the CPU 1001 counts up entries in the “successor component name” in the same component information regardless of any transaction at the S107. A reason why is that the component name filed in the entry of “successor component name” varies depending upon the transaction even for the same component in some cases. The CPU 1001 shifts the process to a S108.

The CPU 1001 decides whether a transaction of a different “successor component name” is present at the S108. If a transaction of a different “successor component name” is present, the CPU 1001 shifts the process to a S109. Meanwhile, if no transaction of a different “successor component name” is present, the CPU 1001 shifts the process to a S110.

The CPU 1001 sets a flag of an exceptional candidate 1 to the visible flag at the S109. The CPU 1001 shifts the process to the S110.

The CPU 1001 checks if all the components are processed at the S110. If all the components are processed, the CPU 1001 ends the process. Meanwhile, unless all the components are processed, the CPU 1001 shifts the process to the S101.

The CPU 1001 thereby stores information for deciding whether the component information is excluded from what is to be visualized in the component information filing DB 612.

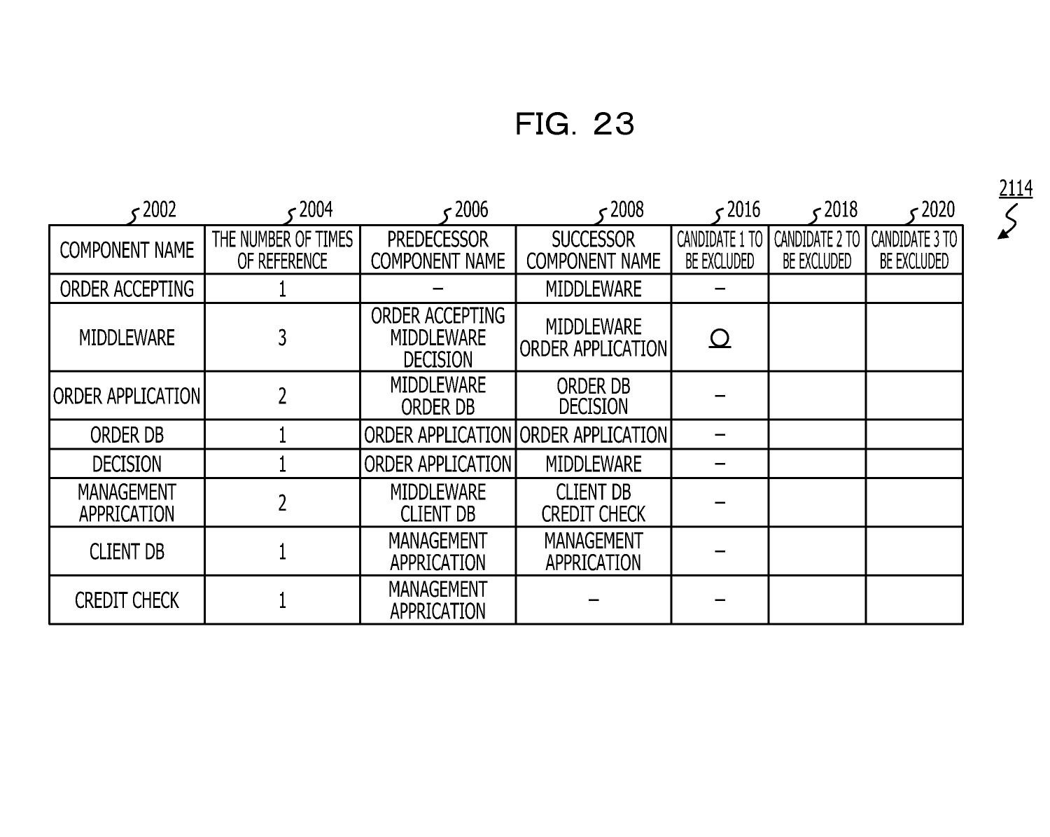

A process run by the component information updating engine 618 will be explained by the use of FIG. 23. The CPU 1001 decides whether “predecessor component name” in the component information of every component includes a same component name as that of the relevant component, and resultantly obtains a table 2114. Set a candidate 1 to be excluded for the middleware component.

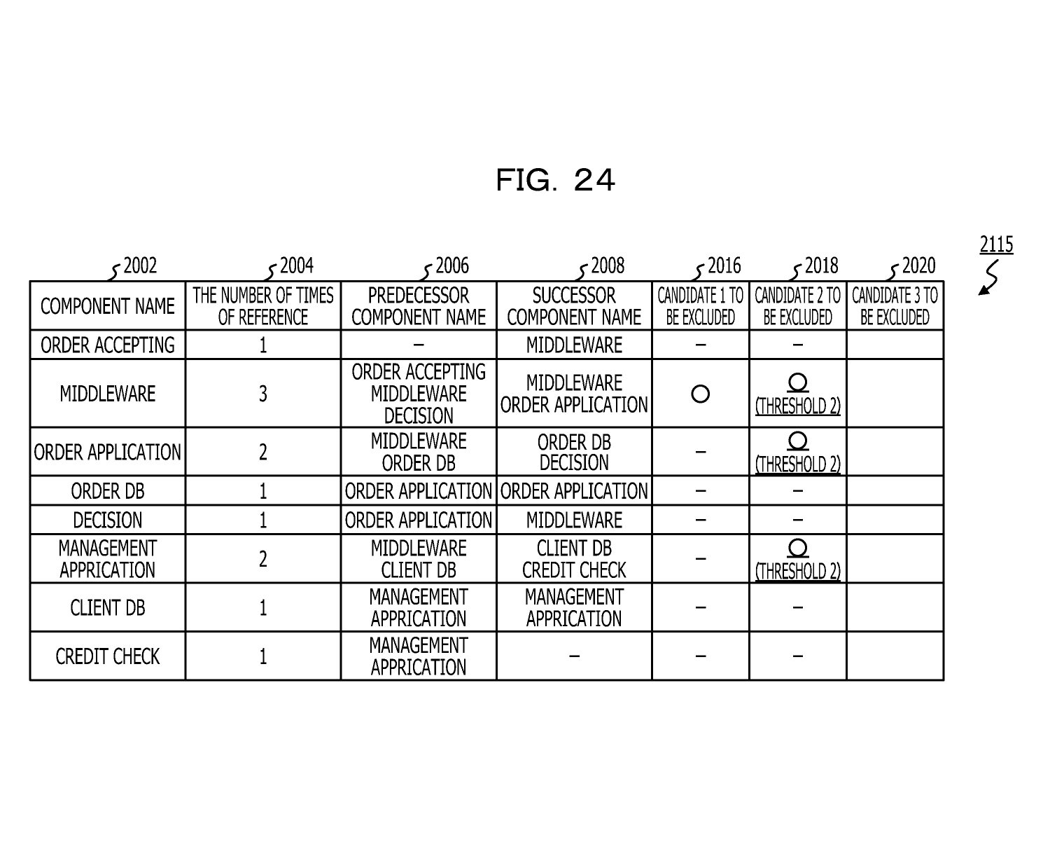

A process run by the component information updating engine 618 will be explained by the use of FIG. 24. The CPU 1001 decides whether “number of times of reference” in the component information of every component values over an initially set threshold “2”, and resultantly obtains a table 2115. The CPU 1001 sets a candidate 2 to be excluded for each of the “middleware”, “order application” and “management application” components.

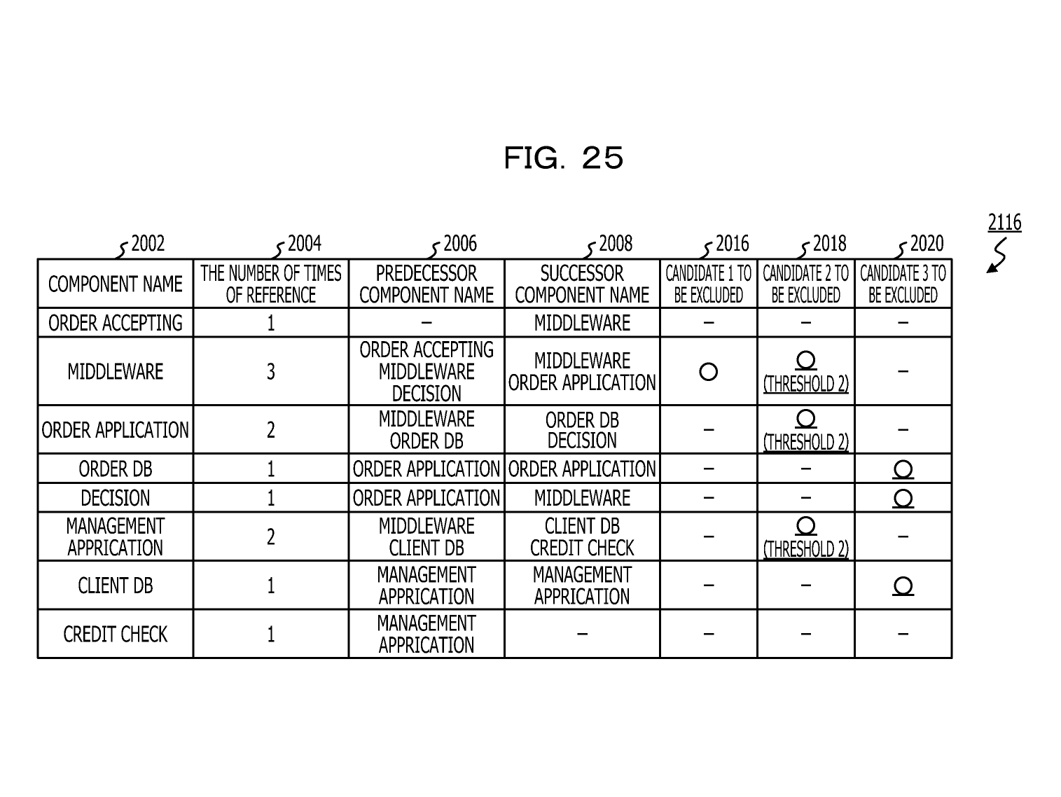

A process run by the component information updating engine 618 will be explained by the use of FIG. 25. The CPU 1001 decides whether the component information of every component includes only one “predecessor component name” and only one “successor component name”, and resultantly obtains a table 2116. The CPU 1001 sets a candidate 3 to be excluded for each of the “order DB”, “decision” and “client DB” components.

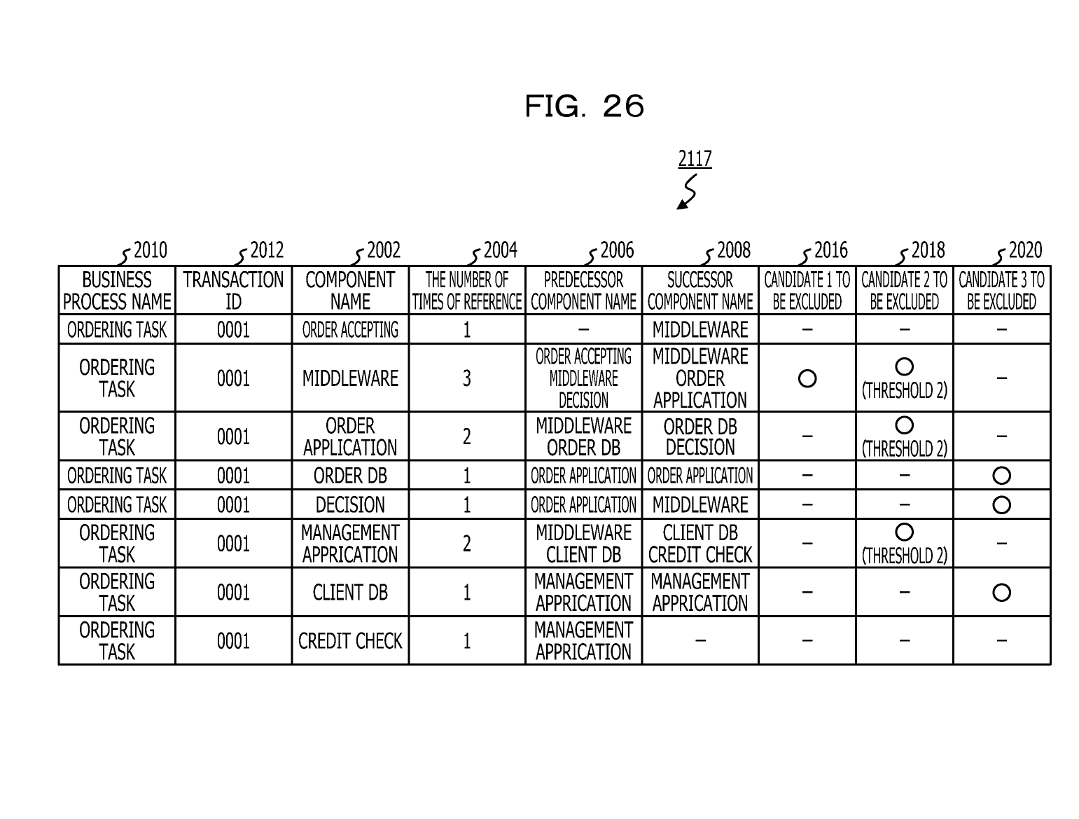

A process run by the component information updating engine 618 will be explained by the use of FIG. 26. The CPU 1001 searches all the transactions regarding the business process name “ordering task” for component information in which the candidate 3 to be excluded is set. As nothing is present except for the component information of the transaction ID “0001” at this time, only the “order DB”, “decision” and “client DB” components are relevant. As those components each have only one “successor component name”, the CPU 1001 sets no exceptional candidate 1, and resultantly obtains a table 2117.

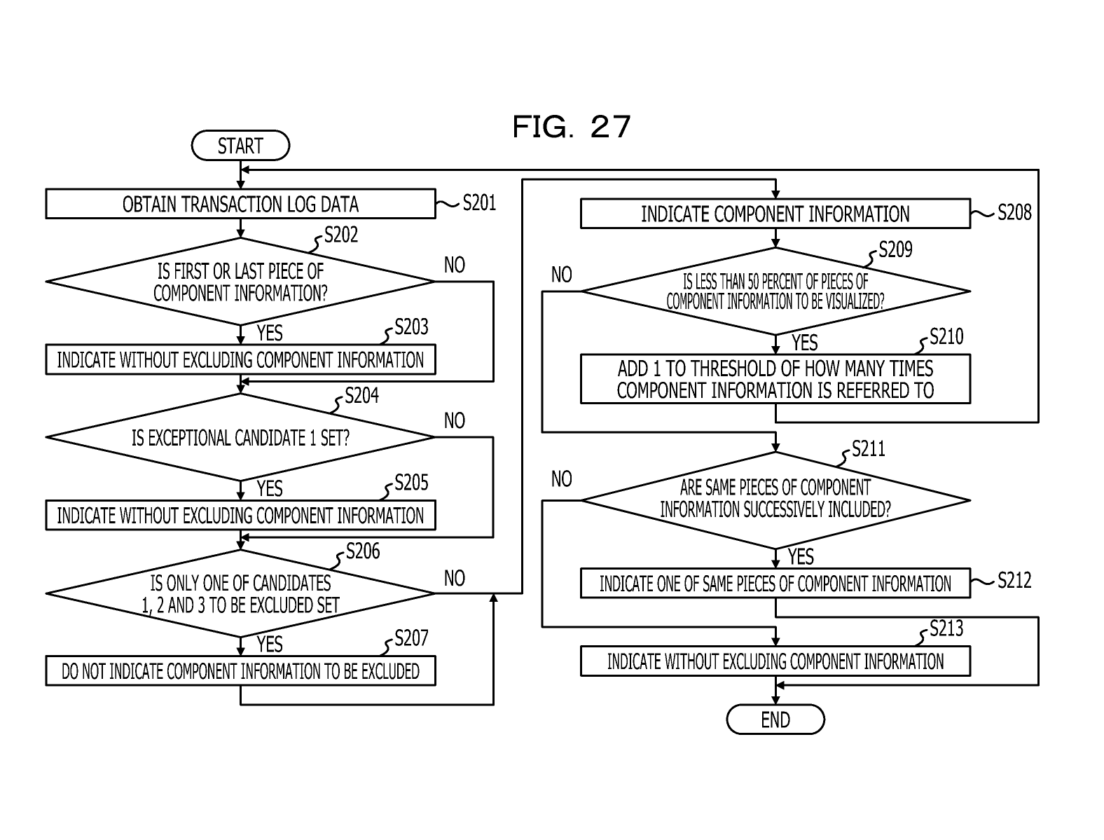

A process run by the transaction log data visualizing engine 614 will be explained by the use of FIG. 27.

The CPU 1001 obtains transaction log data to be visualized from the transaction log data filing DB 608 at a S201. The CPU 1001 shifts the process to a S202.

The CPU 1001 decides whether a certain piece of component information is first or last one in the transaction at the S202. If the piece of component information is first or last one in the transaction, the CPU 1001 shifts the process to a S203. Meanwhile, unless the component information is first or last one in the transaction, the CPU 1001 shifts the process to a S204.

The CPU 1001 does not exclude and indicates the relevant piece of component information at the S203. The CPU 1001 shifts the process to a S204.

The CPU 1001 decides whether the exceptional candidate 1 is set to an excluding flag of a certain piece of component information at the S204. If the exceptional candidate 1 is set to the excluding flag of the relevant component information, the CPU 1001 shifts the process to a S205. Meanwhile, unless the exceptional candidate 1 is set to the excluding flag of the relevant component information, the CPU 1001 shifts the process to a S206.

The CPU 1001 does not exclude and indicates the relevant component information at the S205. The CPU 1001 shifts the process to the S206.

The CPU 1001 decides whether one of the candidates 1, 2 and 3 to be excluded is set to the excluding flag of a certain piece of component information at the S206. If one of the candidates 1, 2 and 3 to be excluded is set to the excluding flag of relevant piece of component information, the CPU 1001 shifts the process to a S207. Meanwhile, unless one of the candidates 1, 2 and 3 to be excluded is set to the excluding flag of relevant piece of component information, the CPU 1001 shifts the process to a S208.

The CPU 1001 excludes and does not indicate the relevant component information at the S207. The CPU 1001 shifts the process to the S208.

The CPU 1001 does not exclude and indicates the relevant component information at the S208. The CPU 1001 shifts the process to a S209.

The CPU 1001 decides whether less than 50 percent of pieces of component information in the transaction are to be visualized as a result of visualization at the S209. If less than 50 percent of pieces of component information in the transaction are to be visualized, the CPU 1001 shifts the process to a S210. Meanwhile, unless less than 50 percent of pieces of component information in the transaction are to be visualized, the CPU 1001 shifts the process to a S211.

The CPU 1001 adds “1” to the threshold of how many times the component information updating engine 618 refers to the component at the S210. The CPU 1001 shifts the process to the S201 and makes a repeated decision to visualize a component in the transaction.

The CPU 1001 decides whether same pieces of component information are successively included in the transaction as a result of choosing a piece of component information to be visualized at the S211. If same pieces of component information are successively included, the CPU 1001 shifts the process to a S212. Meanwhile, unless same pieces of component information are successively included, the CPU 1001 shifts the process to a S213.

The CPU 1001 indicates one of the same pieces of component information at the S212. The CPU 1001 ends the process.

The CPU 1001 does not exclude and indicates the relevant component information at the S213. The CPU 1001 ends the process.

A piece of component information used by a plurality of business applications in common is thereby excluded, and so is a piece of component information being an infrastructure of an IT system. A piece of component information which is specific to a particular business process to be preferably paid attention may be recognized.

Why the CPU 1001 checks whether what is to be visualized is less than 50 percent at the S209 is that the component information is excluded too much in some cases. Upon transaction log data having sufficiently piled up, a quantity of component information that the exceptional candidate 1, etc., is set to increases and what is to be visualized increases. As learning enhances precision, the S210 turns to be processed less frequently.

Incidentally, the highest percentage of the pieces of component information to be visualized is set to 50 percent as a rough criterion. It may be preferable to increase or decrease that value depending upon constitutions of business processes or applications.

A process run by the transaction log data visualizing engine 614 will be explained as to exemplary collected transaction log data related to FIG. 5. The transaction depicted in FIG. 5 is sequentially illustrated in FIG. 6. Further, an updated table in the component information filing DB is the table 2117 depicted in FIG. 27.

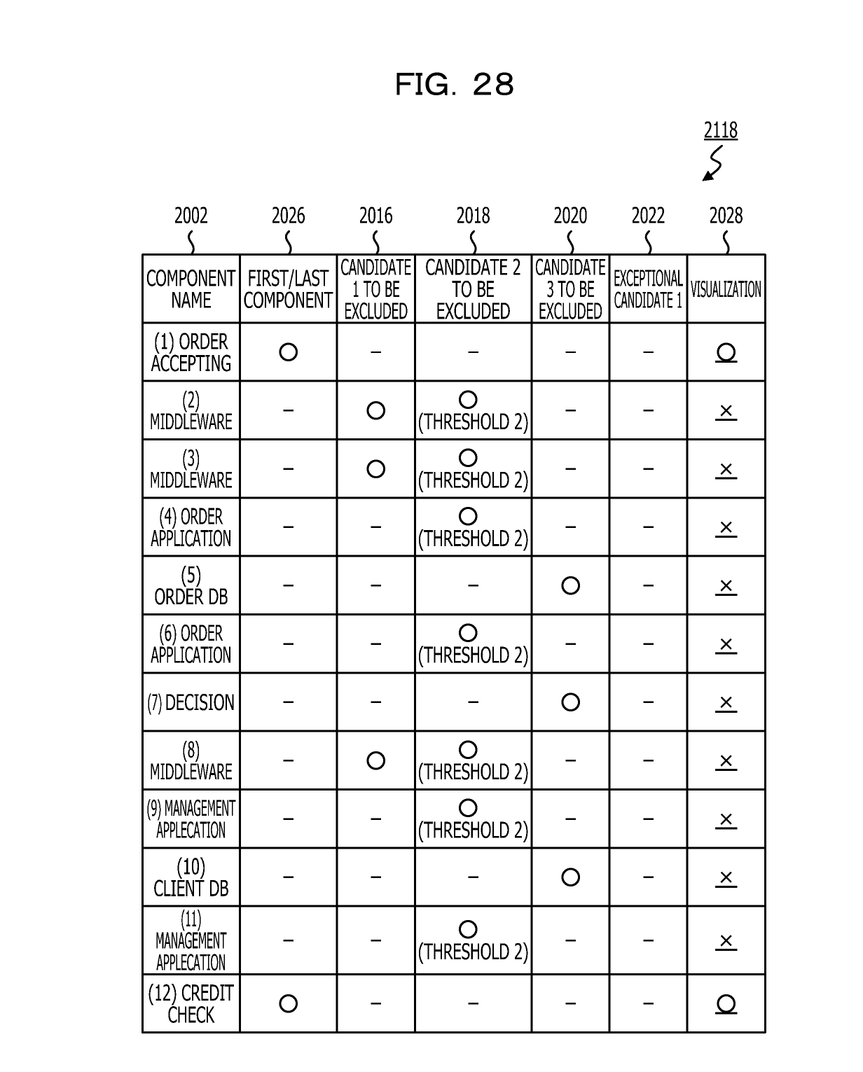

Decide whether the components depicted in FIG. 6 are each to be visualized with reference to a table 2118 depicted in FIG. 28. To begin with, indicate the order accepting component being the first one. The middleware through management application components are not indicated according to the table 2117. Indicate the credit check component being the last one. Thus, the components are indicated or not according to the table 2118 depicted in FIG. 28. As only two of all the twelve components are indicated, only components fewer than 50 percent in the transaction are indicated.

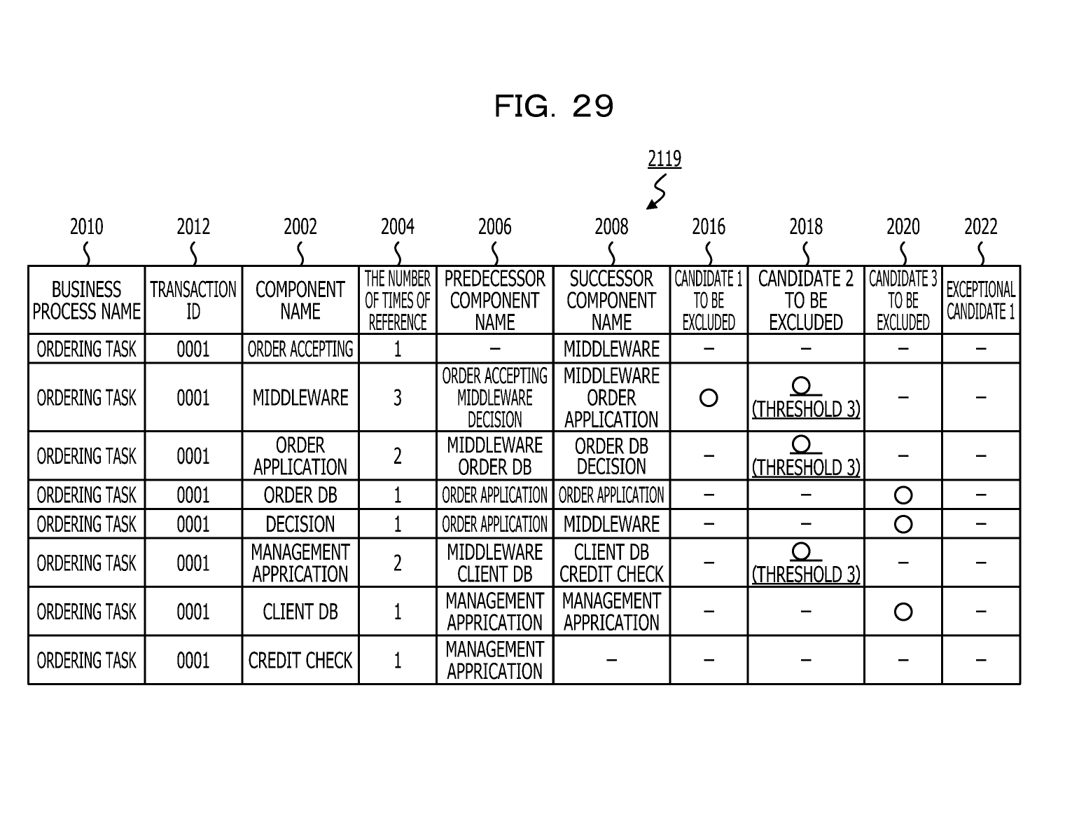

Thus, add 1 to the threshold of how many times the component is referred to which is updated to “3”, and update the table 2102 again so as to resultantly obtain a table 2119 depicted in FIG. 29.

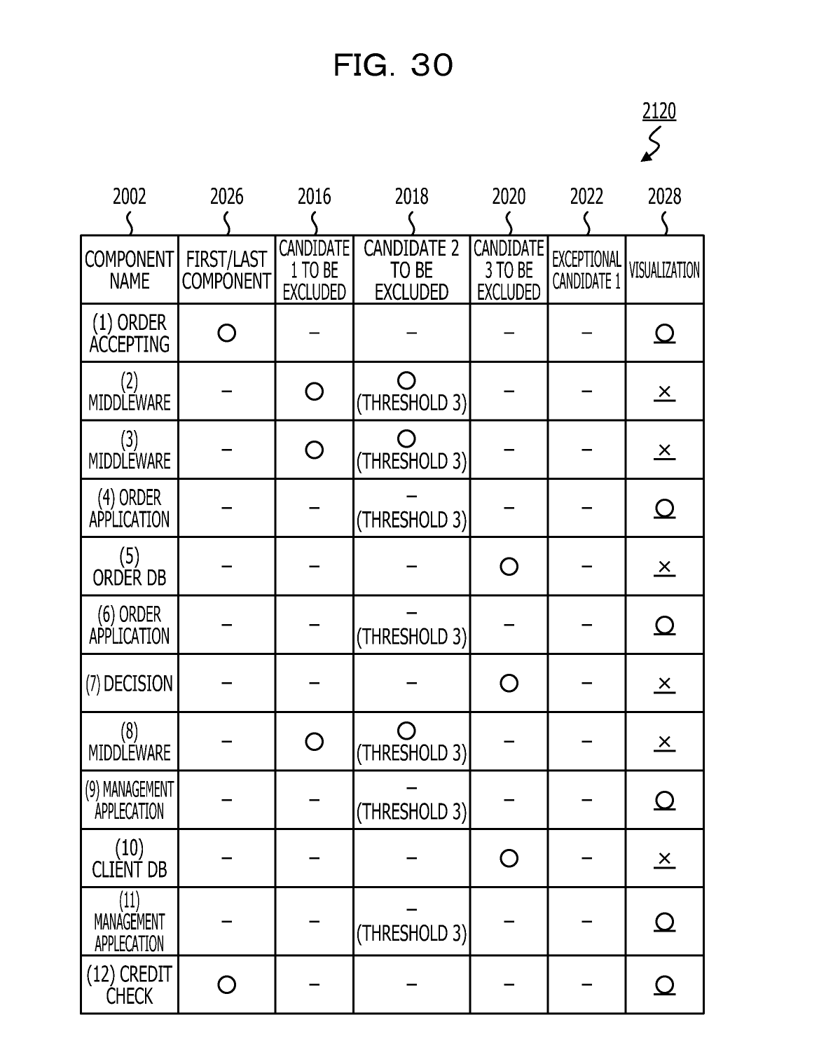

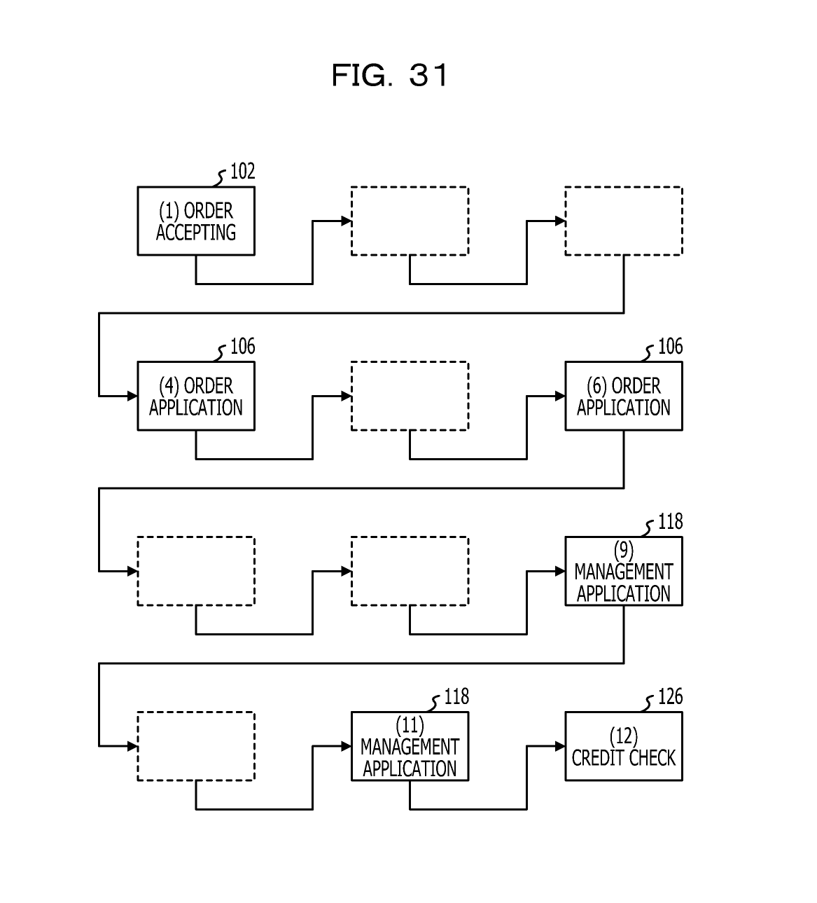

Decide again whether the components depicted in FIG. 6 are each to be visualized with reference to the table 2119 depicted in FIG. 29. Indicate the order accepting component being the first one. The middleware through management application components are not indicated except for the order application and order application components according to the table 2119. The credit check component is indicated being the last one. Thus, the components are indicated or not according to the table 2120 depicted in FIG. 30. Six of all the twelve components are indicated, i.e., the components in the transaction are indicated by 50 percent or more. Thus, exclude undesired components from FIG. 6 resulting in FIG. 31.

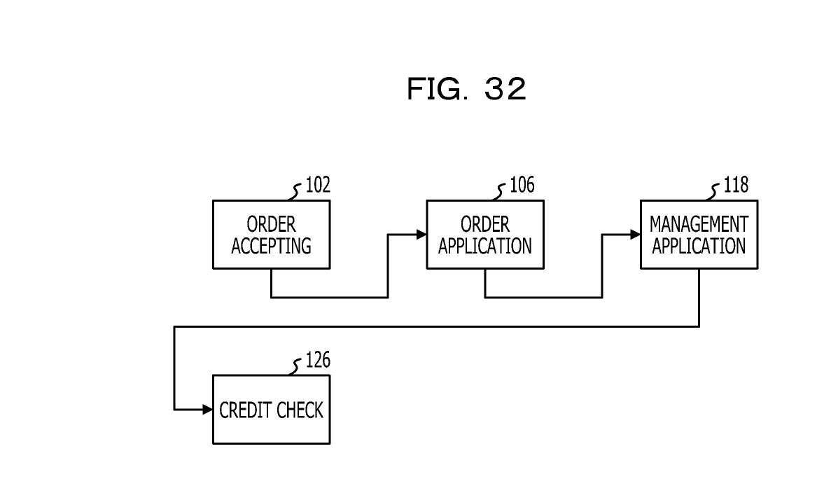

Choose one of two successive pieces of information of same components such as (4) order application component, (6) order application component, (9) management application component and (11) management application component, resulting in a final output depicted in FIG. 32.

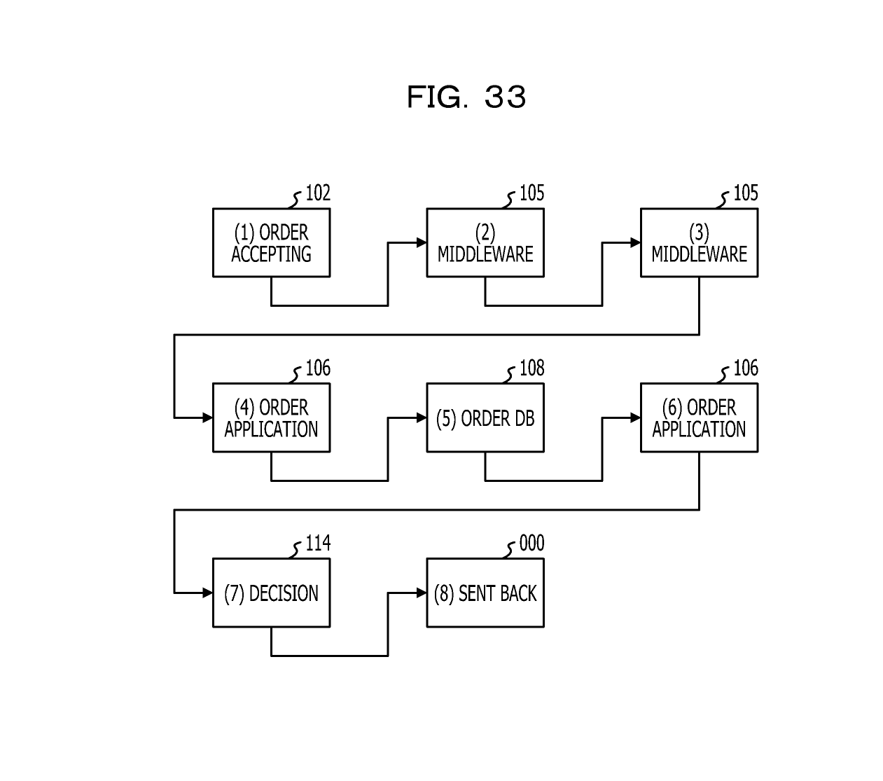

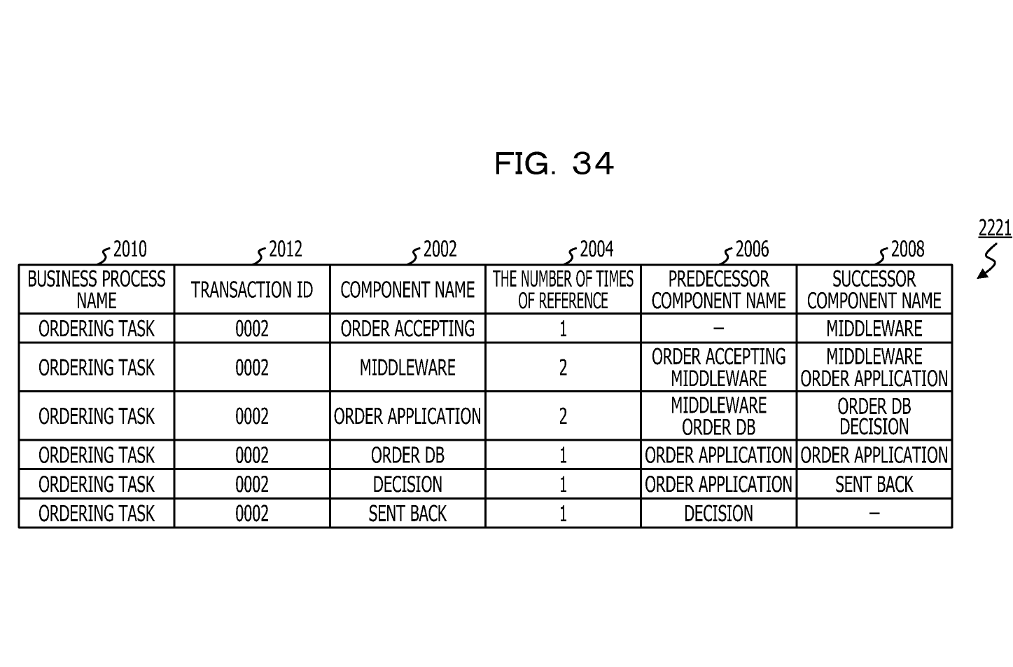

A process run by the transaction log data analysis engine 610 will be explained as to exemplary collected transaction log data related to FIG. 33. Although detailed explanation of the process is omitted, the table 2102 of analyzed transaction log data turns to be a table 2221 depicted in FIG. 34 according to the process.

A process run by the transaction log data analysis engine 610 will be explained as to an example of the table 2221 of the table 2102 of analyzed transaction log data.

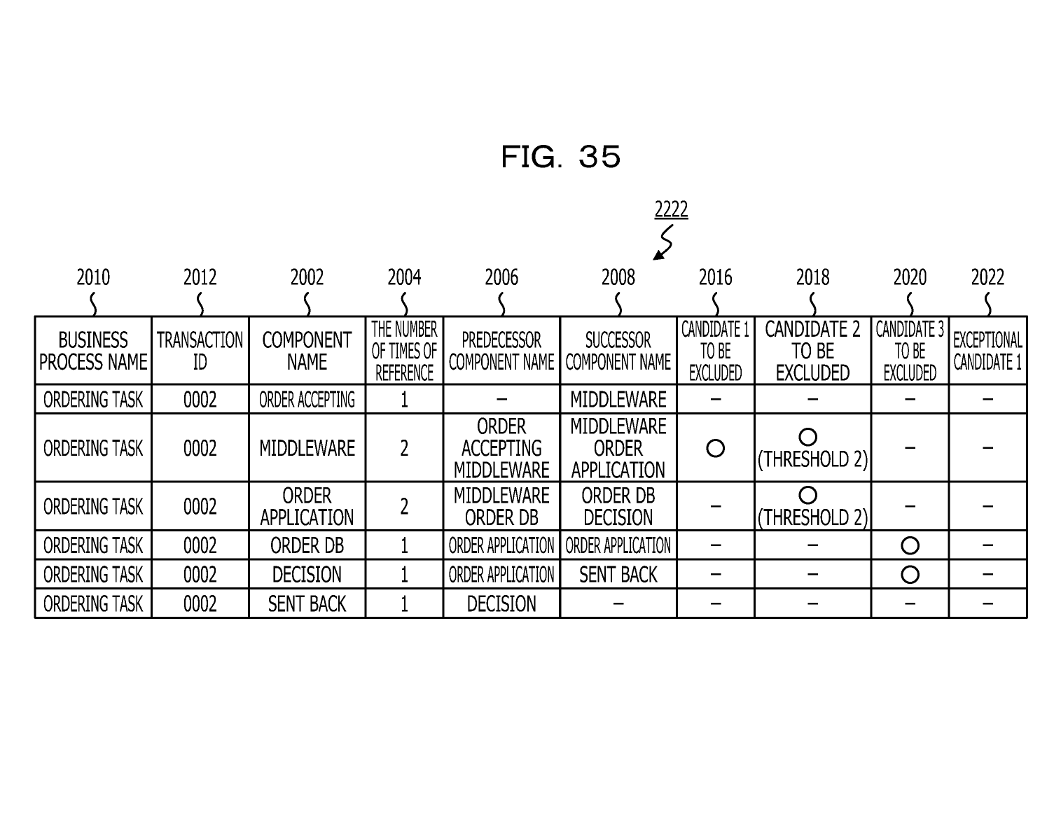

The component information updating engine 618 runs the process described above, and a table 2222 depicted in FIG. 35 is resultantly obtained.

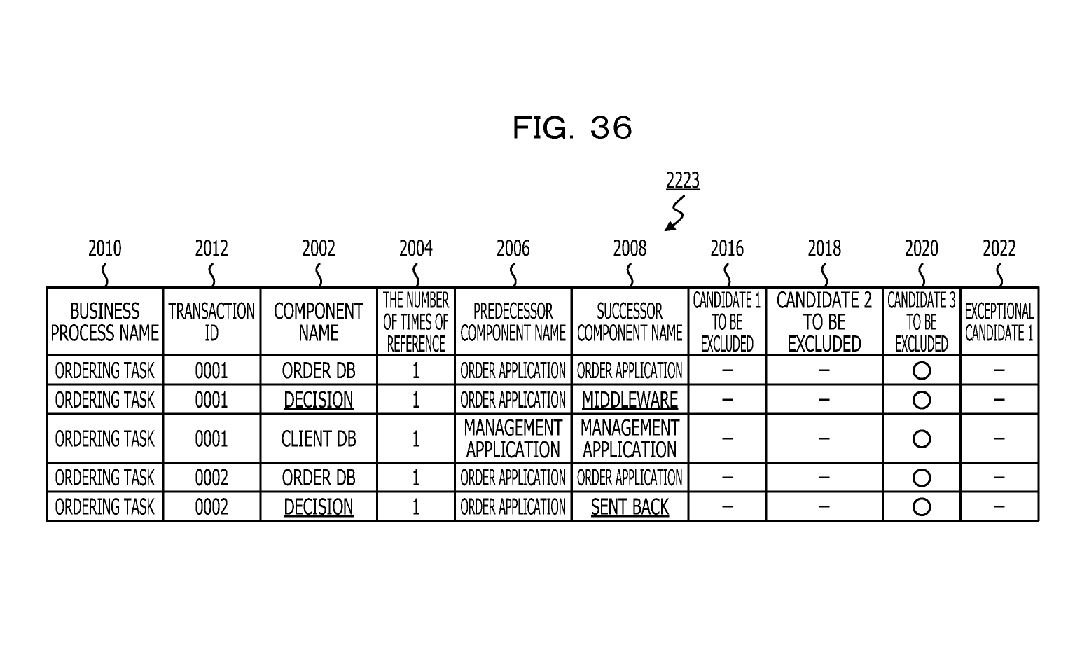

Search all the transactions related to the business process name “ordering task” for a piece of component information that the excluding candidate 3 is set to in the process run by the component information updating engine 618. Count the table 2102 of the transaction IDs “0001” and “0002” resultantly obtained at this time, so as to obtain a table 2223 depicted in FIG. 36.

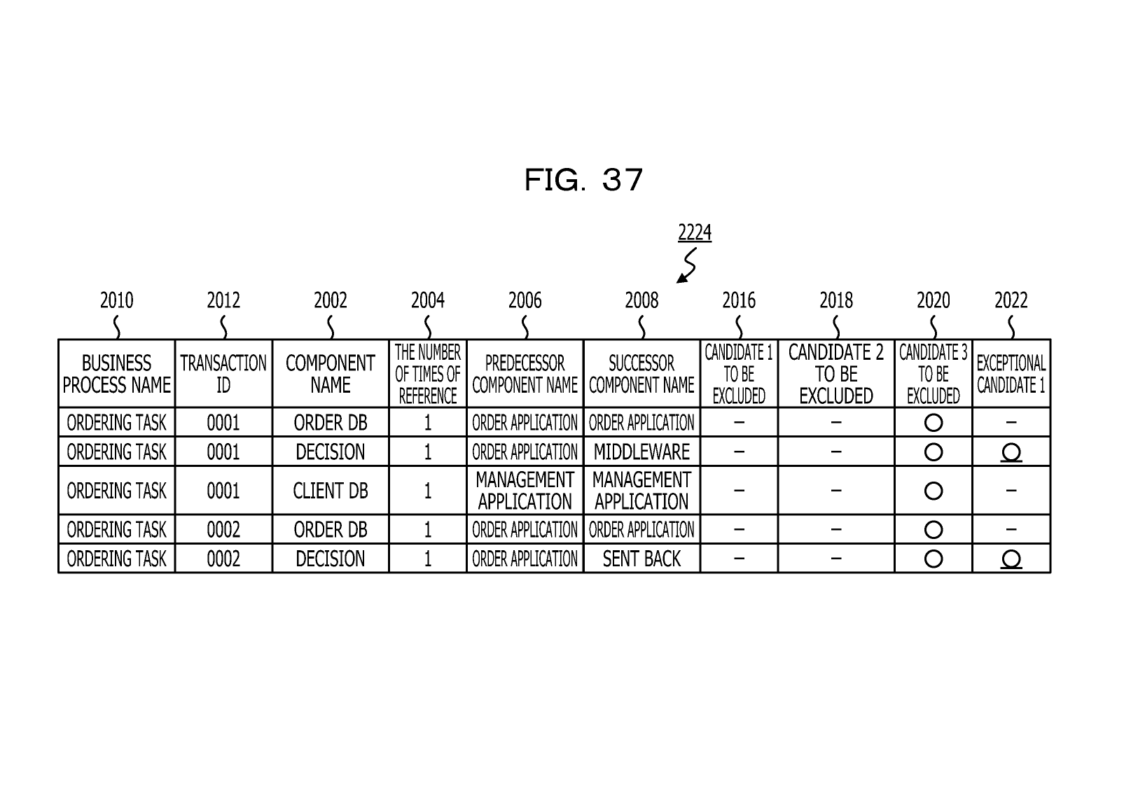

According to the table 2223 depicted in FIG. 36, the decision component has two patterns which are the transaction ID “0001” such that the successor component name is a middleware component and the transaction ID “0002” such that the successor component name is a sent back component. Thus, set the exceptional candidate 1 to the decision component according to the table 2223. Incidentally, as the tables 2119 and 2221 depicted in FIGS. 29 and 34, respectively, are extracted and a table 2224 depicted in FIG. 37 is resultantly obtained, the setting of the exceptional candidate 1 is also reflected in the tables 2119 and 2221 depicted in FIGS. 29 and 34, respectively. The reflection in the table 2221 depicted in FIG. 34 results in the table 2222 depicted in FIG. 35.

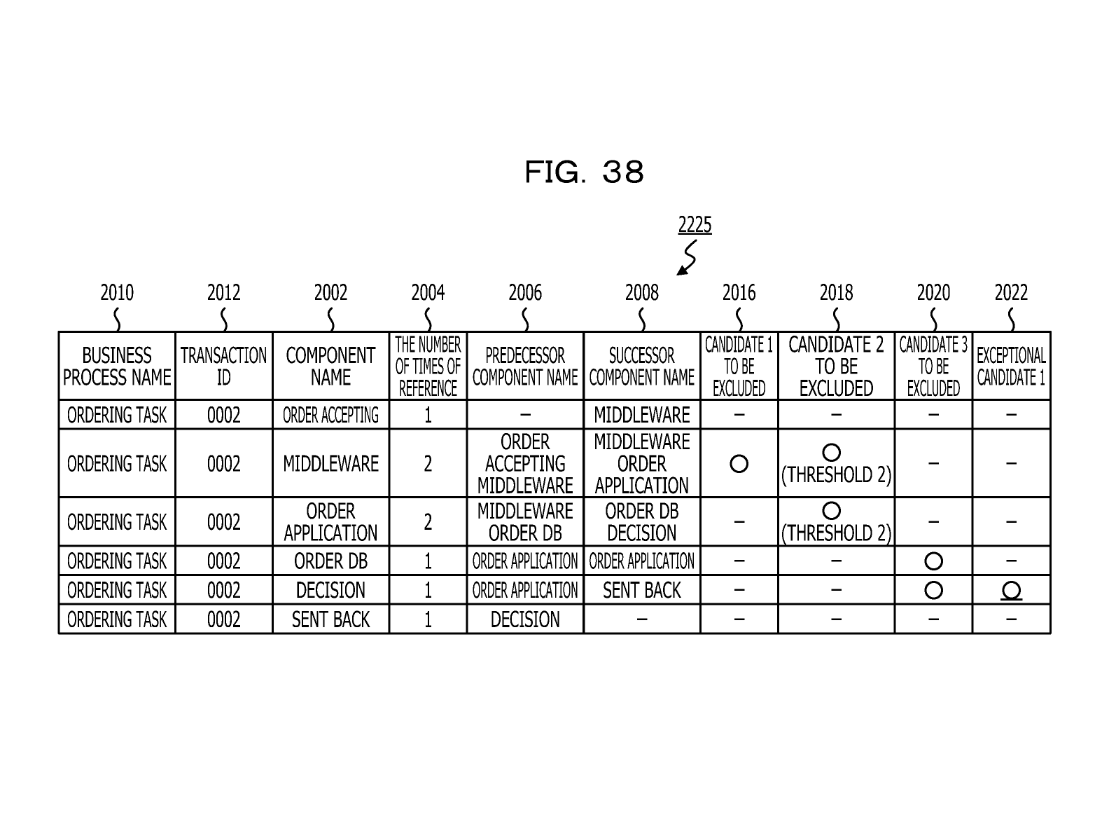

A process run by the transaction log data visualizing engine 614 will be explained as to exemplary collected transaction log data related to FIG. 33. Further, the table 2102 is updated into a table 2225 depicted in FIG. 38.

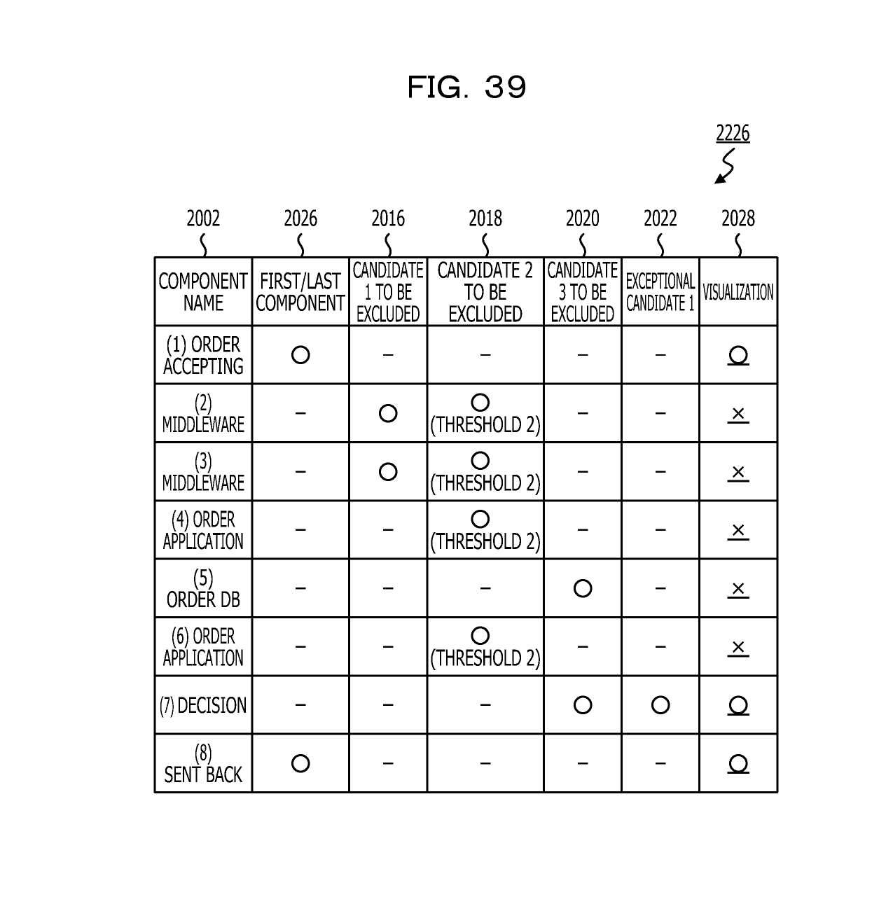

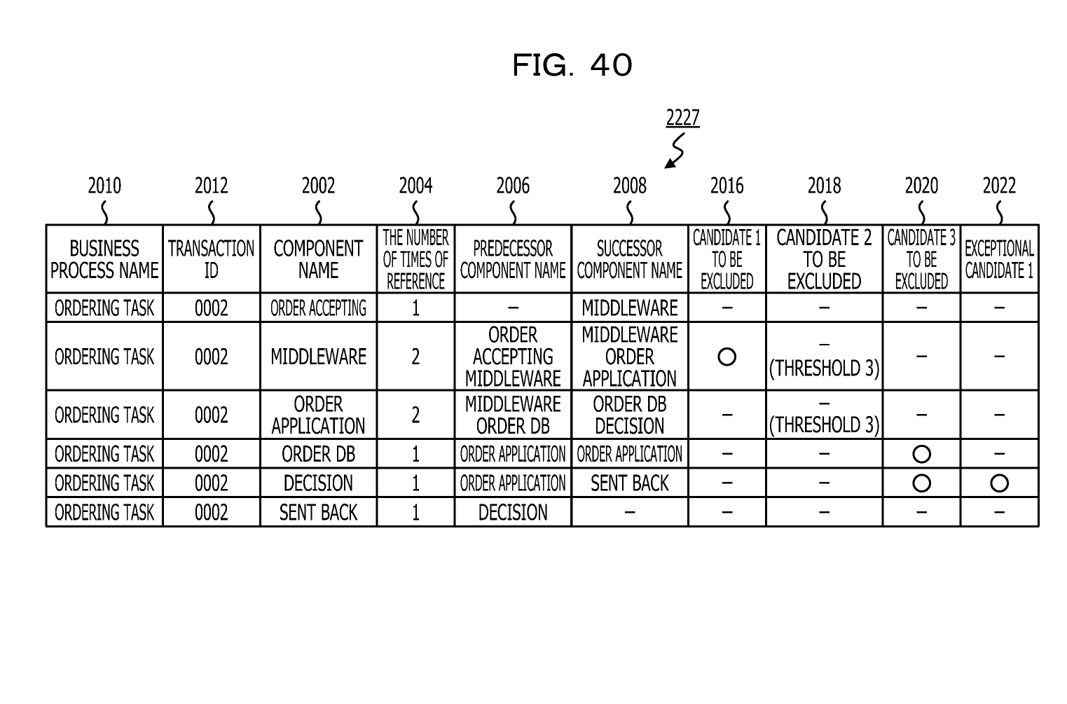

Decide whether the components depicted in FIG. 33 are each to be visualized with reference to the table 2225 depicted in FIG. 38, resulting in a table 2226 depicted in FIG. 39. As the ratio of visualized components is lower than 50 percent, choose the threshold “3” and update the component information filing DB 612, resulting in a table 2227 depicted in FIG. 40.

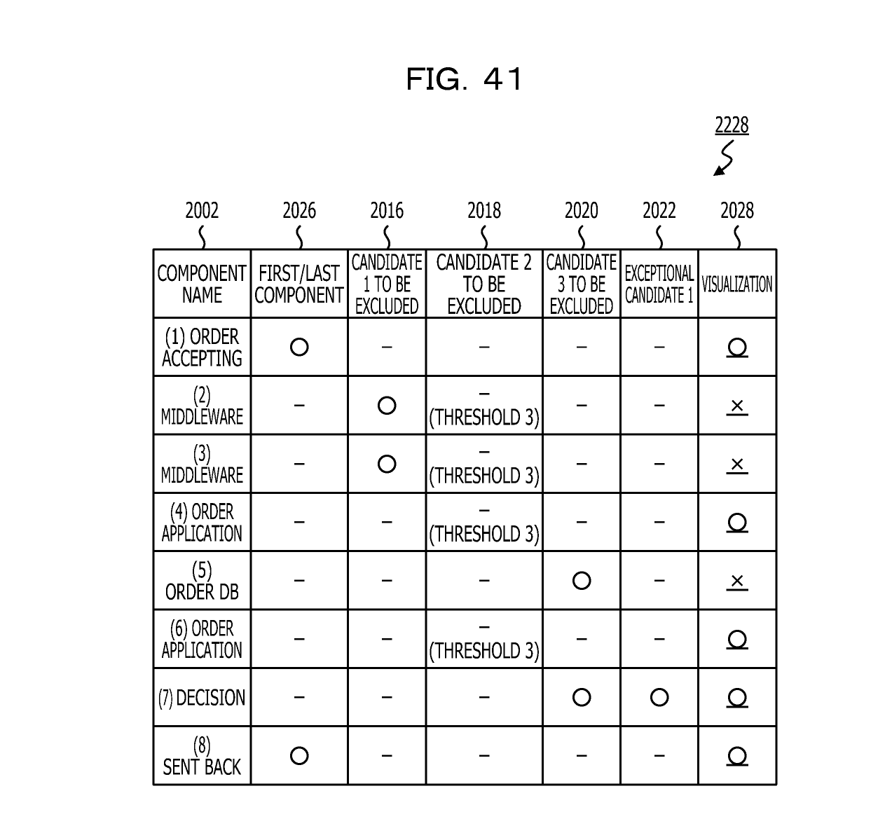

Decide again whether the components depicted in FIG. 33 are each to be visualized with reference to the table 2226 depicted in FIG. 39, resulting in a table 2228 depicted in FIG. 41.

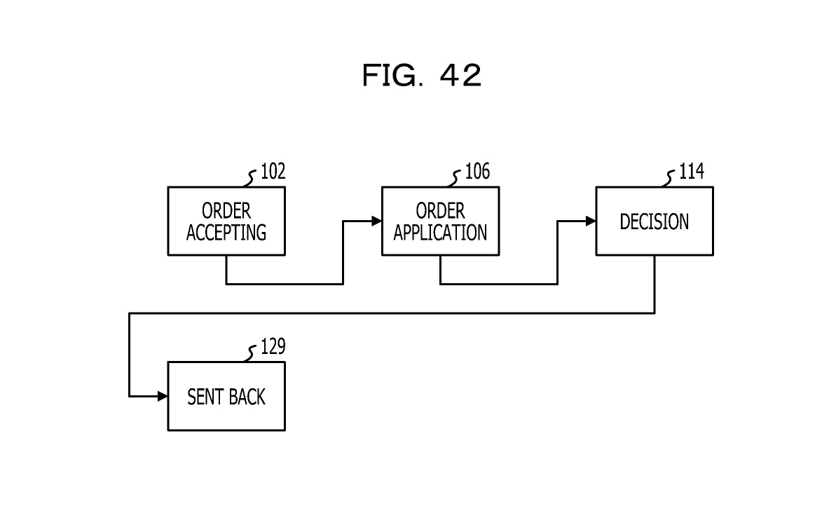

Exclude components from FIG. 33 on the basis of the table 2228 depicted in FIG. 41 and reduce the number of the successive order application components to one, so as to finally output what is drawn in FIG. 42.

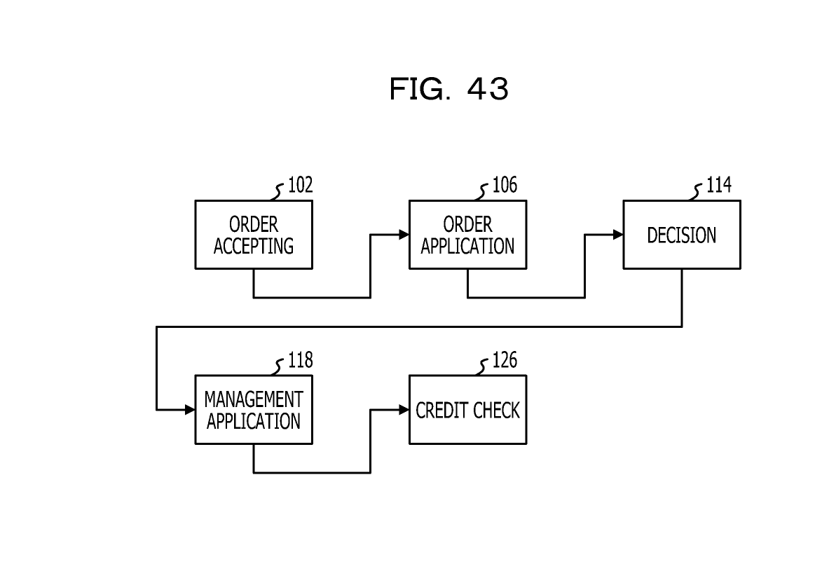

Incidentally, while components are excluded from the transaction log data depicted in FIG. 5 resulting in FIG. 36, the transaction log data depicted in FIG. 29 is analyzed so that the related table 2102 is updated into the table 2119. Thus, apply again the process run by the transaction log data visualizing engine 614 so as to visualize the transaction log data as a final output updated in FIG. 43.

The data processing device of the embodiment is exemplarily explained above. The embodiment is not limited to what is specifically disclosed, and may be variously modified or changed within the scope of the claims. An operation log or trace, e.g., may be used as a communication log.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium storing an analysis supporting program that causes a computer to execute a procedure, the procedure comprising:
reading communication logs concerning a transaction from a storage device that stores the communication logs obtained from a system, which runs a plurality of programs calling one another, each of the communication logs indicating a relationship of calling among the plurality of programs; and
generating order information indicating an order of programs to be run in the transaction excepting at least a program having been run in the transaction repeatedly a certain number of times on the basis of the read communication logs.

2. The recording medium according to claim 1, wherein
the order information indicates the order of programs to be run in the transaction further excepting a program having been consistently run in the transaction.

3. The recording medium according to claim 1, the procedure further comprising:
reading communication logs concerning another transaction which differs from the transaction, wherein
the order information indicates the order of programs to be run in the transaction further excepting a program group having been run in the transaction in a same order as in the another transaction.

4. An analysis supporting method comprising:
reading communication logs concerning a transaction from a storage device that stores the communication logs obtained from a system, which runs a plurality of programs calling one another, each of the communication logs indicating a relationship of calling among the plurality of programs; and
generating, by a processor, order information indicating an order of programs to be run in the transaction excepting at least a program having been run in the transaction repeatedly a certain number of times on the basis of the read communication logs.

5. The analysis supporting method according to claim 4, wherein
the order information indicates the order of programs to be run in the transaction further excepting a program having been consistently run in the transaction.

6. The analysis supporting method according to claim 4, further comprising:
reading communication logs concerning another transaction which differs from the transaction, wherein
the order information indicates the order of programs to be run in the transaction further excepting a program group having been run in the transaction in a same order as in the another transaction.

7. An analysis supporting apparatus comprising:
a storage device that stores communication logs obtained from a system, which runs a plurality of programs calling one another, each of the communication logs indicating a relationship of calling among the plurality of programs; and
a processor that executes a procedure, the procedure including:
reading the communication logs concerning a transaction from the storage device that stores; and
generating order information indicating an order of programs to be run in the transaction excepting at least a program having been run in the transaction repeatedly a certain number of times on the basis of the read communication logs.

8. The analysis supporting apparatus according to claim 7, wherein
the order information indicates the order of programs to be run in the transaction further excepting a program having been consistently run in the transaction.

9. The analysis supporting apparatus according to claim 7, the procedure further comprising:
reading communication logs concerning another transaction which differs from the transaction, wherein
the order information indicates the order of programs to be run in the transaction further excepting a program group having been run in the transaction in a same order as in the another transaction.
